(19) United States
(12) Patent Application Publication
(10) Pub. No.: US 2026/0244659 A1
(43) Pub. Date: Aug. 20, 2026

(54) TECHNIQUES FOR UNDERSTANDING SOFTWARE APPLICATION SESSIONS

(71) Applicant: LogRocket, Inc., Boston, MA (US)

(72) Inventor: Renzo F. Lucioni, Somerville, MA (US)

(73) Assignee: LogRocket, Inc., Boston, MA (US)

(21) Appl. No.: 19/542,354

(22) Filed: Feb. 17, 2026

Related U.S. Application Data
(60) Provisional application No. 63/760,090, filed on Feb. 18, 2025.

(51) Int. Cl. G06F 16/3329; G06F 9/451

(52) U.S. Cl. CPC G06F 16/33295; G06F 9/451

(57) ABSTRACT

Some embodiments provide a system for understanding software application sessions using a large language model (LLM). The system obtains images of graphical user interface content displayed during the sessions, generates textual annotations that describe activity corresponding to the images, and combine the annotated images with instructions into prompt(s) for the LLM. The LLM processes the prompt(s) and may dynamically request targeted additional information through specified functions. The system may be configured to generate responses to queries using the LLM output. As an illustrative example, the LLM output may include natural language summaries of user activity along with embedded links that navigate to particular points in session replays.

### RELATED APPLICATIONS

This application claims the benefit under 35 U.S.C. § 119(e) as a conversion of U.S. Provisional Patent Application No. 63/760,090 titled “TECHNIQUES FOR AUTOMATICALLY SUMMARIZING DIGITAL EXPERIENCES,” filed on Feb. 18, 2025, which is incorporated by reference herein.

### FIELD

Described herein are techniques for understanding software application sessions using large language models, and more particularly for generating information about software application sessions by processing images of graphical user interface content combined with textual annotations describing activity.

### BACKGROUND

A software application may be used by a large number of users (e.g., thousands of users). For example, the software application may be a web application that is accessible by devices using an Internet browser application. The web application may be accessed hundreds or thousands of times on a daily basis by users through various different sessions. As another example, the software application may be a mobile application that can be accessed using a mobile device. Users may interact with the mobile application through a graphical user interface (GUI) of the mobile application presented on mobile devices.

Software applications, including web applications and mobile applications, may be accessed by large numbers of users through various devices on a daily basis. Users interact with software applications through graphical user interfaces during software application sessions, where each session represents a time period of user interaction with the application. Understanding what users experience during these sessions can provide valuable information for software development, technical support, and product improvement. However, the volume of sessions that occur across a user base can make it impractical to manually review individual sessions to understand user experiences, identify problems, or assess how users interact with application features.

Various approaches have been developed to capture and analyze data from software application sessions. However, extracting meaningful insights from session data at scale remains challenging, as the raw data captured during sessions may be voluminous and require interpretation to understand the context and significance of user activity.

### SUMMARY

Technology described herein provides a system for understanding software application sessions using a large language model (LLM). The system obtains images of graphical user interface content displayed during the sessions, generates textual annotations that describe activity corresponding to the images, and combine the annotated images with instructions into prompt(s) for the LLM. The LLM processes the prompt(s) and may dynamically request targeted additional information through specified functions. The system may be configured to generate responses to queries using the LLM output. As an illustrative example, the LLM output may include natural language summaries of user activity along with embedded links that navigate to particular points in session replays.

In some embodiments, the techniques described herein relate to a large language model (LLM)-based software application session understanding system, the system including: a processor; and a non-transitory computer-readable storage medium storing instructions that, when executed by the processor, cause the processor to: receive a query requesting information about at least one software application session of a software application; obtain a plurality of images of graphical user interface (GUI) content displayed at points in the at least one software application session; generate textual annotations for the plurality of images of GUI content displayed at the points in the at least one software application session; process, using a large language model (LLM), the plurality of images of the GUI content and the textual annotations for the plurality of images to obtain LLM output, the processing including: generate at least one prompt for the information requested by the query at least in part by including, in the at least one prompt, the plurality of images combined with the textual annotations and instructions for the LLM; and communicate with the LLM using the at least one prompt to obtain the LLM output; and generate a response to the query using the LLM output obtained from processing the plurality of images of the GUI content and the textual annotations.

In some embodiments, the techniques described herein relate to a method for understanding software application sessions using a large language model (LLM)-based, the method including: using a processor to perform: receiving a query requesting information about at least one software application session of a software application; obtaining a plurality of images of graphical user interface (GUI) content displayed at points in the at least one software application session; generating textual annotations for the plurality of images of GUI content displayed at the points in the at least one software application session; processing, using a large language model (LLM), the plurality of images of the GUI content and the textual annotations for the plurality of images to obtain LLM output, the processing including: generating at least one prompt for the information requested by the query at least in part by including, in the at least one prompt, the plurality of images combined with the textual annotations and instructions for the LLM; and communicating with the LLM using the at least one prompt to obtain the LLM output; and generating a response to the query using the LLM output obtained from processing the plurality of images of the GUI content and the textual annotations.

In some embodiments, the techniques described herein relate to a non-transitory computer-readable medium storing instructions that, when executed by a processor, cause the processor to perform a method for understanding software application sessions using a large language model (LLM)-based, the method including: receiving a query requesting information about at least one software application session of a software application; obtaining a plurality of images of graphical user interface (GUI) content displayed at points in the at least one software application session; generating textual annotations for the plurality of images of GUI content displayed at the points in the at least one software application session; processing, using a large language model (LLM), the plurality of images of the GUI content and the textual annotations for the plurality of images to obtain LLM output, the processing including: generating at least one prompt for the information requested by the query at least in part by including, in the at least one prompt, the plurality of images combined with the textual annotations and instructions for the LLM; and communicating with the LLM using the at least one prompt to obtain the LLM output; and generating a response to the query using the LLM output obtained from processing the plurality of images of the GUI content and the textual annotations.

In some embodiments, the techniques described herein relate to a system for automatically summarizing digital experiences in which users interact with a software application in a plurality of software application sessions, the system including: a processor; and a non-transitory computer-readable storage medium storing instructions that, when executed by the processor, cause the processor to perform steps of: identifying, in the plurality of software application sessions, periods of user activity via a graphical user interface (GUI) of the software application; sampling a plurality of images of software application GUIs displayed in the plurality of software application sessions during the identified periods; prompting a large language model (LLM) using the plurality of images of the software application GUIs to obtain a first output, the prompting including providing at least some of the plurality of images of the software application GUIs as input to the LLM; and prompting the LLM using the first output to obtain a natural language summary of the plurality of software application sessions. In some embodiments, the steps further comprise sampling information about user activity during the identified periods, wherein prompting the LLM to obtain the first output further comprises providing at least some of the information about user activity (e.g., textual information) as input to the LLM in combination with the at least some images of the software application GUIs.

In some embodiments, the techniques described herein relate to a method for automatically summarizing digital experiences in which users interact with a software application in a plurality of software application sessions. The method comprises steps of: identifying, in the plurality of software application sessions, periods of user activity via a graphical user interface (GUI) of the software application; sampling a plurality of images of software application GUIs displayed in the plurality of software application sessions during the identified periods; prompting a large language model (LLM) using the plurality of images of the software application GUIs to obtain a first output, the prompting including providing at least some of the plurality of images of the software application GUIs as input to the LLM; and prompting the LLM using the first output to obtain a natural language summary of the plurality of software application sessions. In some embodiments, the steps further comprise sampling information about user activity during the identified periods, wherein prompting the LLM to obtain the first output further comprises providing at least some of the information about user activity (e.g., textual information) as input to the LLM in combination with the at least some images of the software application GUIs.

In some embodiments, the techniques described herein relate to a non-transitory computer-readable medium storing instructions that, when executed by at least one processor, cause the at least one processor to perform steps of: identifying, in the plurality of software application sessions, periods of user activity via a graphical user interface (GUI) of the software application; sampling a plurality of images of software application GUIs displayed in the plurality of software application sessions during the identified periods; prompting a large language model (LLM) using the plurality of images of the software application GUIs to obtain a first output, the prompting including providing at least some of the plurality of images of the software application GUIs as input to the LLM; and prompting the LLM using the first output to obtain a natural language summary of the plurality of software application sessions. In some embodiments, the steps further comprise sampling information about user activity during the identified periods, wherein prompting the LLM to obtain the first output further comprises providing at least some of the information about user activity (e.g., textual information) as input to the LLM in combination with the at least some images of the software application GUIs.

### BRIEF DESCRIPTION OF FIGURES

Non-limiting and non-exhaustive examples are described with reference to the following figures.

FIG. 1A illustrates a block diagram of a software application session understanding system, according to some embodiments of the technology described herein.

FIG. 1B illustrates a block diagram of an example processing pipeline within the software application session understanding system of FIG. 1A, according to some embodiments of the technology described herein.

FIG. 2 illustrates a block diagram of a prompt used in the software application session understanding system, according to some embodiments of the technology described herein.

FIG. 3 illustrates a sequence diagram representing an interaction process between an LLM processing module and an LLM, according to some embodiments of the technology described herein.

FIG. 4 illustrates a flowchart for an example process for responding to queries requesting information about software application sessions, according to some embodiments of the technology described herein.

FIG. 5 illustrates a session list interface for searching and filtering user sessions, according to some embodiments of the technology described herein.

FIG. 6 illustrates a session list interface displaying sessions with natural language summaries, according to some embodiments of the technology described herein.

FIG. 7 illustrates a weekly issues digest interface displaying top issues by severity, according to some embodiments of the technology described herein.

FIG. 8 illustrates an error title translation table that shows conversion of technical error titles into natural language titles, according to some embodiments of the technology described herein.

FIG. 9 illustrates a GUI for displaying and triaging user struggle issues, according to some embodiments of the technology described herein.

FIG. 10 illustrates a GUI displaying session context for support requests, according to some embodiments of the technology described herein.

FIG. 11 illustrates a chat interface providing session information in response to user support inquiries, according to some embodiments of the technology described herein.

FIG. 12 illustrates a chat interface displaying a summary of a user's software application session experience with visual evidence, according to some embodiments of the technology described herein.

FIG. 13 illustrates a request fields table specifying parameters for requesting session summaries, according to some embodiments of the technology described herein.

FIG. 14 illustrates an example computer system that may be configured to implement some embodiments of the technology described herein.

### DETAILED DESCRIPTION

Described herein are improved techniques for understanding software application sessions executed by user devices. The techniques employ a large language model (LLM) to generate information about software application sessions, such as summaries of activity in the sessions, descriptions of problems that occurred in the sessions, and/or other information.

Software applications may be accessed and used by large numbers of users on a daily basis. For example, a software application may be a web application accessed by various users through an Internet browser application. As another example, a software application may be a mobile application accessed by various users using mobile devices such as smartphones or tablets. A software application may thus be accessed by users in a large number of sessions every day, by various user devices. A session refers to a time period in which a user interacts with a software application. A session may be represented by a sequence of events representing a user's perspective of the operation of the software application in a time period. A session may be delimited by certain events. For example, a session of a web application may begin when a device accesses the web application using an Internet browser application and end when the device navigates away from the web application. As another example, a session of a mobile application may begin when the mobile application is initiated on a mobile device and end when the mobile application is closed. As another example, a session may end after a certain time period of inactivity.

Understanding user experiences across software application sessions at scale presents technical challenges. Manually reviewing sessions to understand what users experienced is impractical when thousands of sessions occur daily. Prior approaches to automated session analysis encountered limitations. For example, purely image-based analysis of sessions led to inaccuracies because images alone may not provide sufficient context to understand what actions a user performed or what the user intended to accomplish. Additionally, providing all available data about a session at once to a computational analysis system is expensive in terms of computational resources and yields lower-quality output because the analysis system may be overwhelmed by the volume of information. Further, the system may not be able to identify the most relevant data to use in generating an output.

Conventional machine learning approaches to session understanding have relied on models trained on large datasets to predict whether identified issues and friction points are important, with importance based on vectors such as impact, frequency, and user feedback. However, such approaches encounter limitations when attempting to provide meaningful explanations of user experiences. For example, prior machine learning systems do not provide natural language explanations of what occurred during a session or why an issue affected users. Additionally, prior automated analysis systems that generated summaries or descriptions of user sessions did not reference specific points in session data that support generated statements. As a result, it is difficult to verify the accuracy of the output or to understand the basis for the system's conclusions. Furthermore, conventional approaches to digital experience summarization that are purely image-based lead to inaccuracies because images alone may not provide sufficient context to a machine learning model to understand what actions a user performed or what the user intended to accomplish. For example, an image of a GUI may show a button or form field, but without additional information about user interactions, an analysis system may be unable to determine whether the user clicked on the button, what text the user entered, or what sequence of actions led to the displayed state.

Technology described herein addresses the above-described challenges by providing improved techniques that use a large language model (LLM) to understand software application sessions. The techniques generate information about the software application sessions (e.g., in response to queries requesting information about software application session(s)). For example, the information may include summaries of activity in the sessions, descriptions of problems that occurred in the sessions, and/or other information responsive to queries about the sessions. The techniques combine images of graphical user interface (GUI) content with textual annotations that describe activity in the software application sessions (e.g., user actions), thereby providing context that improves the accuracy of interpretations compared to image-only approaches. The action descriptions in the annotations provide context to improve interpretations of the images, addressing inaccuracies that occurred when only images were provided.

Some embodiments provide an LLM-based software application session understanding system. The system obtains images of graphical user interface (GUI) content displayed at points in one or more software application sessions (e.g., by accessing images of a generated replay of the software application session(s)). The system further generates textual annotations for the images of GUI content displayed at the points in the software application session(s). The system processes, using a large language model (LLM), the images of the GUI content and the textual annotations for the plurality of images to obtain LLM output. The system generates one or more prompts by including, in the prompt(s), the images of the GUI content combined with the textual annotations and instructions for the LLM. The system communicates with the LLM using the prompt(s) to obtain the LLM output (e.g., through an automated exchange of communications with the LLM). In some embodiments, the system may be configured to perform the processing to respond to a query for information about software application session(s) (e.g., to respond to a request for a summary of activity in the software application session(s)).

In some embodiments, the LLM-based software application session understanding system may operate iteratively by allowing the LLM to dynamically choose to request additional information through function calls before generating the final output. Rather than providing all available data at the onset, which would be expensive and may reduce output quality, the system allows the LLM to selectively request additional information as needed during processing. The request from the LLM may trigger execution of function(s) to generate the requested information. For example, the LLM may request network request and response information, console log entries, or session metadata at specific points in the session when such information would be useful for responding to a prompt. The iterative approach reduces computational costs and improves the quality of the generated output by allowing the LLM to focus on information that is relevant to a request.

Some embodiments further provide evidence points from the sessions that support statements made in an output. Prior automated analysis systems that generated summaries or descriptions of user sessions often functioned as opaque systems that provided output without supporting evidence. Without this, it is too much of a black-box to depend on. Some embodiments described herein address this challenge by generating output that includes citations to specific points in the session data (e.g., points in session replays) that support the generated content. This may further be used to embed links in the summary content and may include in-line screenshots that can be put in the summary. This approach improves trust of output by allowing users to verify the accuracy of the generated information against the underlying session data.

Furthermore, sampling during periods when the user is inactive may be wasteful (i.e., more expensive) because it is unlikely that the system will obtain information relevant to understanding a user's experience during such periods. Prior approaches that sampled session data uniformly without regard to user activity levels consumed unnecessary computational resources, processing periods of inactivity that contributed little to understanding the user's experience. Some embodiments described herein address this challenge by identifying, in the software application sessions, periods of user activity via a graphical user interface (GUI) of the software application (e.g., by identifying portions of the software application sessions in which there is at least a threshold frequency of user activity) and sampling images of software application GUIs displayed in the software application sessions during the identified periods of user activity. This selective sampling approach reduces computational costs while focusing analysis on the portions of sessions that are most likely to contain relevant information about the user's experience.

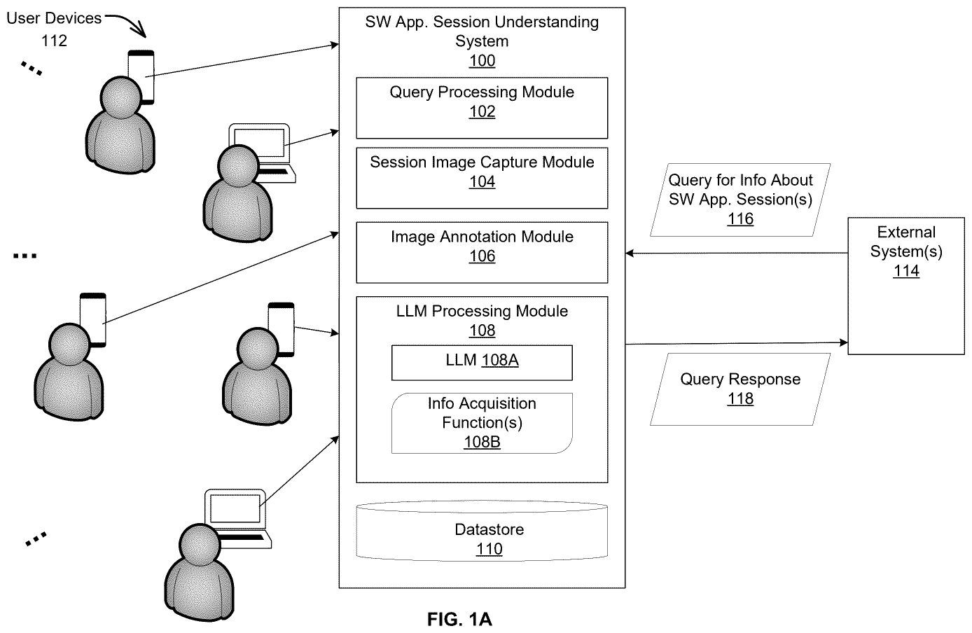

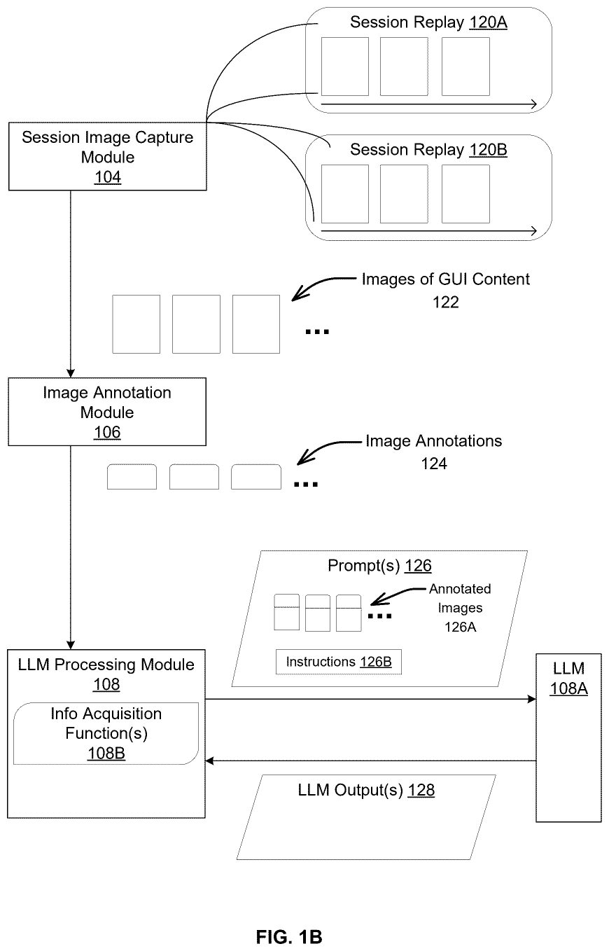

FIG. 1A illustrates a block diagram of a software (SW) application (app.) session understanding system 100 (also referred to herein as “the system 100”), according to some embodiments of the technology described herein. As illustrated in FIG. 1A, in some embodiments the system 100 may be configured to receive and process queries related to software application sessions. The system 100 includes a query processing module 102, a session image capture module 104, an image annotation module 106, an LLM processing module 108, and a datastore 110. The query processing module 102 may be configured to receive and handle incoming queries from user devices and external systems. The session image capture module 104 may be configured to capture images from software application sessions. The image annotation module 106 may be configured to process and annotate the captured images with textual descriptions of user activity. The datastore 110 may be configured to store data used by the system 100, including session data, captured images, and generated annotations.

Referring again to FIG. 1A, the system 100 may be configured to obtain data from user devices 112. User devices 112 may include various device types including desktop computers and mobile devices, indicating that the system 100 may receive input from a variety of user device configurations. External system(s) 114 communicate with the system 100 through a communication network. The external system(s) 114 send a query 116 for information about software application session(s) 116 to the system 100. The query 116 represents queries sent from the external system(s) 114 to the system 100 requesting information about software application sessions. The system 100 provides a query response 118 back to the external system(s) 114 through the communication network. The query response 118 represents the information returned in response to the query 116, generated using output of the LLM 108A.

In some embodiments, the system 100 may be configured to expose interface(s) through which the system 100 may receive queries from external systems and process the queries to generate a response using the techniques described herein. The system 100 may expose the session understanding techniques through as a tool that may receive user queries. For example, the external system(s) 114 may include a ticketing system, a customer relationship management system, or another system that transmits queries and, as a result, invokes the system 100 to obtain information about software application sessions relevant to those queries.

With continued reference to FIG. 1A, the query 116 may request information about software application session(s). For example, the query 116 may request information about portions of sessions that meet a query condition, a summary of what happened during a particular time period, a summary of what happened in all the software application session(s), information about a problem that occurred in the software application session(s), or specific information about software functionality that may be used to improve software applications. It should be appreciated that example types of information mentioned herein are for illustrative purposes. Some embodiments may be configured to process queries that request other types of information in addition to or instead of the types of information mentioned specifically herein. This targeted approach allows the system 100 to generate responses that address specific information needs rather than providing only general summaries.

As further shown in FIG. 1A, the LLM processing module 108 may be configured to use an LLM 108A and information (info) acquisition function(s) 108B. The LLM 108A may be configured to process information and generate responses based on prompts that include annotated images and instructions. The info acquisition function(s) 108B may be configured to provide mechanisms for acquiring additional information during processing, as described above with respect to the iterative processing approach that allows the LLM 108A to dynamically request additional information. The LLM 108A may be implemented using various types of large language models. In some embodiments, the LLM 108A may be a transformer-based language model that processes input sequences using self-attention mechanisms. The LLM 108A may be an autoregressive language model that generates output tokens sequentially based on preceding tokens and input context. In some embodiments, the LLM 108A may be a multi-modal model capable of processing both text and images, enabling the model to interpret the images of GUI content in combination with the textual annotations. The LLM 108A may be an instruction-tuned model that has been trained to follow natural language instructions provided in prompts. In some embodiments, the LLM 108A may be a model that supports function calling capabilities, enabling the model to trigger execution of the info acquisition function(s) 108B during processing. In some embodiments, the LLM 108A may be hosted by a system separate from the system 100 (e.g., and accessed by the system 100 through an application programming interface (API)). In some embodiments, the LLM 108A may be a model hosted locally by the system 100. In some embodiments, the LLM 108A may be a model that has been fine-tuned for tasks related to understanding user interfaces, describing user activity, or summarizing software application sessions.

In some embodiments, the LLM 108A may be a foundation LLM (e.g., a pre-trained LLM). Example LLMs that may be used as the LLM 108A include the Gemini 2.5 Pro model developed by Google, the Gemini 3 Flash model developed by Google, the Claude model developed by Ahtropic, The GPT model developed by OpenAI, the Gemma model developed by Google, a LlaMa model developed by Meta, a DeepSeek model developed by DeepSeek, or another suitable foundation LLM. In some embodiments, the LLM 108A may be obtained by fine-tuning a foundation LLM. For example, the LLM 108A may be fine-tuned on curated examples of instruction-response pairs. A training algorithm (e.g., stochastic gradient descent) may be applied to the curated examples to fine-tune the foundation LLM to obtain the LLM 108A that the LLM processing system 108 is configured to use. In some embodiments, the LLM 108A may be obtained by performing training to generate the LLM 108A. For example, the LLM 108A may be trained by applying a stochastic gradient descent algorithm to training data to learn parameters (e.g., weights) of the LLM 108A.

FIG. 1B illustrates a block diagram of an example processing pipeline within the software application session understanding system 100 of FIG. 1A, according to some embodiments of the technology described herein. Referring to FIG. 1B, the session image capture module 104 receives a session replay 120A and a session replay 120B as inputs. The session replay 120A and the session replay 120B represent replays of software application sessions that have been generated from recorded session data. In some embodiments, the session image capture module 104 may be configured to generate replay(s) of software application session(s) and capture images of GUI content from the replay(s) of the software application session(s). The session image capture module 104 may be configured to process the session replay 120A and the session replay 120B to generate images of GUI content 122. The images of GUI content 122 are represented as a sequence of image frames that capture visual representations of the graphical user interface displayed during the software application session(s).

In some embodiments, the system 100 may be configured to generate a replay of a software application session (e.g., for capturing images of GUI content displayed in the software application session by the session image capture module 104) using techniques for capturing and replicating session data. The datastore 110 may store records associated with respective sessions of an application executed by a device, where each record may store data for replicating a sequence of visualizations rendered in the application during a respective session. The record may be accessed by a session replay system in order to replay a session by replicating visualizations rendered from the session in a replay GUI. A data capture module may capture the data associated with the sequence of visualizations as the visualizations are being rendered. For example, the data capture module may be executed as part of the application. The data capture module may obtain data associated with the visualizations and transmit the data for storage in a datastore of the session replay system for use in replicating the sequence of visualizations by a replication module. Example parameters of which values may be collected include hypertext markup language (HTML) document object model (DOM) tree changes such as node additions, deletions, and mutations, CSS styles and/or stylesheets, and navigation events such as page loads and/or change in history. Techniques for generating replays of software application sessions are described in U.S. Pat. No. 12,216,892, titled “Techniques for replaying a mobile application session,” and U.S. Pat. No. 11,966,320, titled “Techniques for capturing software application session replay data from devices,” each of which is incorporated herein by reference in its entirety.

In some embodiments, the session image capture module 104 may be configured to capture images of the GUI content of a software application session using techniques other than capturing the images from a session replay. For example, the session image capture module 104 may collect images by obtaining image(s) of a portion of an application GUI. The session image capture module 104 may identify a location of an area of interest in the application GUI (e.g., an area including a graphical element that is updated as part of rendering a visualization in the application GUI). For example, the session image capture module 104 may identify the coordinates of a boundary of the area of interest. In some embodiments, the session image capture module 104 may identify the location of a graphical element by obtaining information from a software object (e.g., an instance of a software class) indicating location information (e.g., coordinates) of a boundary of the graphical element. The session image capture module 104 may then obtain an image of a portion of the application GUI using the location information. For example, the session image capture module 104 may take a screen capture of the portion of the application GUI using the location information (e.g., by clipping to coordinates of a boundary of a graphical element). As another example, a software object may include a method that, when executed, returns an image of the graphical element represented by the software object. The session image capture module 104 may execute the method to obtain the image(s) of the rendered visualization. As yet another example, the session image capture module 104 may record video of a session and extract frames from the recorded video as images of GUI content.

In some embodiments, the session image capture module 104 may be configured to identify points in a software application session for which to capture images based on user activity. The session image capture module 104 may identify, in the software application sessions, periods of user activity via a graphical user interface (GUI) of the software application (e.g., by identifying portions of the software application sessions in which there is at least a threshold frequency of user activity). The session image capture module 104 may sample images of GUI content during the identified periods of user activity (e.g., from a session replay). Sampling during periods when the user is inactive may be wasteful (i.e., more expensive) because it is unlikely that the system will obtain information relevant to understanding a user's experience during such periods. In some embodiments, the session image capture module 104 may determine a change in frequency of user activity in the GUI at a point in the software application session and obtain images of the GUI based on determining the change in frequency of user activity in the GUI. The session image capture module 104 may sample images from identified periods of user activity in various ways. In some embodiments, for example, the session image capture module 104 may use a dynamic sampling interval, use soft and hard frame limits, and/or use other suitable techniques of sampling images. Example user activity may comprise changes in cursor position, click count, touch interaction count, click coordinates, touch surface interaction coordinates, scroll coordinates, and/or interaction with input elements.

In some embodiments, the session image capture module 104 may be configured to enqueue image requests in batches for efficient processing. For example, the session image capture module 104 may enqueue screenshot requests. The session image capture module 104 may generate batches of screenshot requests, where each batch includes multiple screenshot requests with specific video times and file names. For example, the session image capture module 104 may generate a batch of screenshot requests that includes requests for screenshots at video times spaced at regular intervals, such as every two seconds. For example, each screenshot request in a batch may include an application identifier, a recording identifier, a session identifier, a tab identifier, an SDK type, a session date, an array of video times for which screenshots are requested, a requesting service identifier, and an array of request objects. Each request object may include a mode field indicating the type of capture (e.g., “screenshot”), a video time field indicating the specific time in the session for which the screenshot should be captured, and a file name field indicating a storage location for the captured screenshot. The file name may include a hash-based path that uniquely identifies the screenshot based on session and timing information.

In some embodiments, the session image capture module 104 may be configured to process timeline entries from the software application session. Timeline entries may represent events that occurred during the session, such as user actions, navigation events, and system responses. The session image capture module 104 may retrieve timeline entries for a specified tab identifier and time range. For example, the session image capture module 104 may retrieve 112 timeline entries for a tab within a specified start time and end time. The session image capture module 104 may process the timeline entries to identify points in the session where user actions occurred.

In some embodiments, the session image capture module 104 may be configured to add timeline entry frames to correlate actions with images. The session image capture module 104 may associate each timeline entry with a corresponding image from the images of GUI content 122. The session image capture module 104 may determine the video time at which each timeline entry occurred and identify the screenshot that corresponds to that video time. The session image capture module 104 may track the time required to add timeline entry frames. For example, the session image capture module 104 may record that adding timeline entry frames required approximately 2,281 milliseconds. The correlation of timeline entries with images allows the image annotation module 106 to generate the image annotations 124 that accurately describe user actions at specific points in the session, with each annotation associated with a corresponding image from the images of GUI content 122.

With continued reference to FIG. 1B, the images of GUI content 122 are provided to the image annotation module 106. The image annotation module 106 may be configured to generate image annotations 124 for the images of GUI content 122. In some embodiments, the image annotations 124 provide textual descriptions of user activity corresponding to the GUI content captured in the images. The image annotation module 106 may be configured to generate, for each of one or more of the images of GUI content 122, text describing a user action being performed at a particular point in the software application session(s). In some embodiments, the image annotations 124 may use a timestamped action list format that includes timestamps, action descriptions, and sampled images in a list format indicating time, action, and image. For example, the image annotations 124 may include information about tabs and text that is being clicked on, interleaved with the images of GUI content 122. For example, an entry in the image annotations 124 may indicate a timestamp value, a description of an action such as “the user clicks on” followed by the text of an element being clicked, and a corresponding image from the images of GUI content 122. The images of GUI content 122 may be sampled independently of the actions and interspersed with the action descriptions in the image annotations 124.

In some embodiments, the image annotations 124 may use a timestamped action list format that includes timestamps, action descriptions, and sampled images in a list format indicating time, action, and image. For example, the image annotations 124 may include information about tabs and text that is being clicked on, interleaved with the images of GUI content 122. For example, an entry in the image annotations 124 may indicate a timestamp value, a description of an action such as “the user clicks on” followed by the text of an element being clicked (e.g., “The user clicks on ‘Victoria, TX-EAST Bulkplant’” or “The user clicks on ‘Confirm’”), and a corresponding image from the images of GUI content 122. As another example, an entry in the image annotations 124 may indicate that a user is active in a particular tab (e.g., “The user is active in tab” followed by a tab identifier). The images of GUI content 122 may be sampled independently of the actions and interspersed with the action descriptions in the image annotations 124.

In some embodiments, the image annotation module 106 may be configured to generate textual annotations by translating data collected during a software application session into a sequence of events that occurred in the session. The image annotation module 106 may determine a sequence of events comprising a sequence of user actions (e.g., click/touch interactions, GUI elements/screens viewed by the user, and/or other user actions) that were performed in the session. The image annotation module 106 may order the sequence of events based on an order in which they occurred during the session. As an illustrative example, data collected from a session may indicate the following event corresponding to a user navigating to a webpage: {type: ‘NavigationEvent’, data: {action: ‘PAGE_LOAD’, href: ‘https://example.com’}, time: 1696968408402}. In this example, the image annotation module 106 may translate the event into a textual transcription of a user action that reads “Navigated to https://example.com”. As another example, data collected from a session may indicate the following event corresponding to a user clicking on a button in a browser that is labeled “Add to Cart”: {type: ‘MouseEvent’, data: {action: ‘CLICK’, text: ‘Add to Cart’} , time: 1696968408402}. In this example, the image annotation module 106 may translate the event into a textual transcription of a user action that reads “Clicked on Add to Cart”.

As another example, data collected from a session may include a document object model (DOM) tree indicating the structure and content of a GUI visible to the user. The image annotation module 106 may extract text (e.g., that is displayed to the user in the GUI) from the DOM tree into entries of a session representation. For example, the image annotation module 106 may generate an annotation entry indicating that a user “Saw text” followed by text extracted from the DOM tree that was displayed to the user in the GUI. Example annotation entries may include entries such as “Navigated to https://checkin.example.com/itinerary/123ABC”, “Clicked on 33B”, “Saw text Section Regular Seat regular Standard seat 10° recline angle USB Port Personal touchscreen Seat 33B-Regular Select passenger”, “Clicked on 12.34 USD”, and “Saw text There was an error when selecting your seats. Try again.”

In some embodiments, the image annotation module 106 may generate annotations indicating various types of user activity. For example, the image annotation module 106 may generate annotations indicating navigation events (e.g., page loads and/or changes in history), click events indicating text or elements that a user clicked on, touch interaction events, scroll events, and/or interactions with input elements. In some embodiments, the image annotation module 106 may associate each annotation with a timestamp indicating when the corresponding event occurred in the software application session.

As further shown in FIG. 1B, the image annotations 124 and the images of GUI content 122 are combined to form prompt(s) 126. The prompt(s) 126 include annotated images 126A and instructions 126B. The annotated images 126A combine the images of GUI content 122 with the corresponding image annotations 124. The instructions 126B provide directives for the LLM 108A to follow when processing the input. The prompt(s) 126 are provided to the LLM processing module 108. Within the LLM processing module 108, the LLM 108A receives the prompt(s) 126 and generates LLM output(s) 128. The LLM output(s) 128 represent the responses generated by the LLM 108A based on the annotated images 126A and the instructions 126B provided in the prompt(s) 126. For example, the LLM output(s) 128 may include natural language summaries, descriptions of user activity, or responses to specific queries about the software application sessions.

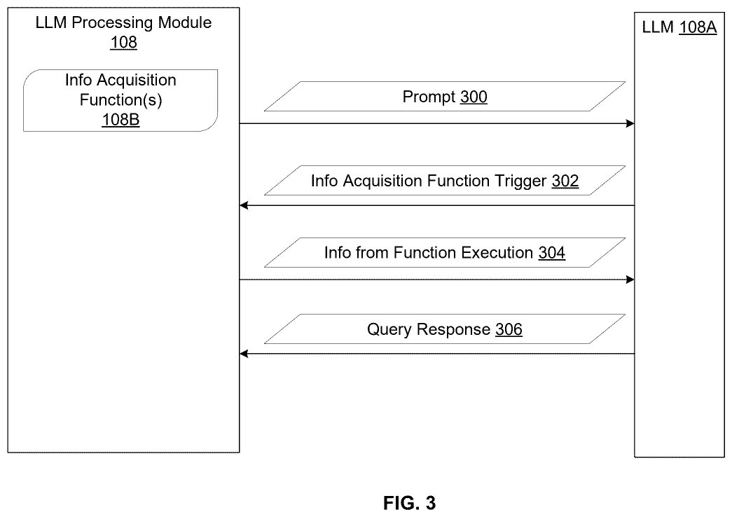

In some embodiments, the LLM processing module 108 may be configured to implement performance degradation logic to maintain efficiency when processing requests. The LLM processing module 108 may monitor the elapsed time during processing of a request and compare the elapsed time against a threshold value. When the elapsed time exceeds the threshold value, the LLM processing module 108 may degrade performance by reducing the level of reasoning effort applied by the LLM 108A. For example, the LLM processing module 108 may reduce the number of iterations permitted for the iterative interaction process described above with respect to FIG. 3, limit the number of info acquisition function triggers 302 that the LLM 108A may issue, or reduce the complexity of reasoning requested from the LLM 108A. The performance degradation logic allows the LLM processing module 108 to balance processing quality against response time requirements, ensuring that requests complete within acceptable time limits, such as under 3 minutes.

In some embodiments, the LLM processing module 108 may be configured to implement input truncation logic to handle cases when inputs are too massive. The LLM processing module 108 may determine the size of the input data to be provided to the LLM 108A, including the annotated images 126A and the instructions 126B. When the size of the input data exceeds a threshold size, the LLM processing module 108 may truncate the input data to reduce the size to a level that the LLM 108A can process effectively. The truncation may involve reducing the number of images of GUI content 122 included in the prompt(s) 126, reducing the length of the image annotations 124, or removing portions of the instructions 126B. The input truncation logic prevents the LLM 108A from being overwhelmed by excessive input data, which may degrade the quality of the LLM output(s) 128 or cause processing failures.

In some embodiments, the LLM processing module 108 may be configured to track and report metrics associated with processing requests. The metrics may include input tokens, which represent the number of tokens in the input provided to the LLM 108A. The metrics may further include cached tokens, which represent the number of tokens that were retrieved from a cache rather than being processed anew by the LLM 108A. The metrics may additionally include thinking tokens, which represent the number of tokens generated by the LLM 108A during internal reasoning processes, such as the reasoning documented in thought sections of the LLM output(s) 128. The metrics may also include output tokens, which represent the number of tokens in the LLM output(s) 128 generated by the LLM 108A. The metrics may further include latency, which represents the elapsed time for processing the request, measured in milliseconds. The metrics may additionally include the number of iterations, which represents the count of iterative exchanges between the LLM processing module 108 and the LLM 108A during processing of a single request.

In some embodiments, the LLM processing module 108 may be configured to use token caching to reduce computational costs associated with processing requests. The LLM processing module 108 may store tokens from previously processed inputs in a cache and retrieve the cached tokens when processing subsequent requests that include similar or identical input content. The cached tokens may represent a portion of the input tokens for a request. For example, when the LLM processing module 108 reports 27,164 input tokens and 23,620 cached tokens, the cached tokens represent approximately 87 percent of the input tokens, indicating that a majority of the input content was retrieved from the cache rather than being processed anew. The token caching reduces the computational resources consumed by the LLM 108A when processing requests that share common input content, such as requests that include the same specification of info acquisition functions 206, the same LLM configuration instructions 208, or the same replay idiosyncrasy instructions 210. The token caching allows the LLM processing module 108 to process requests more efficiently by avoiding redundant processing of input content that has been previously processed and cached.

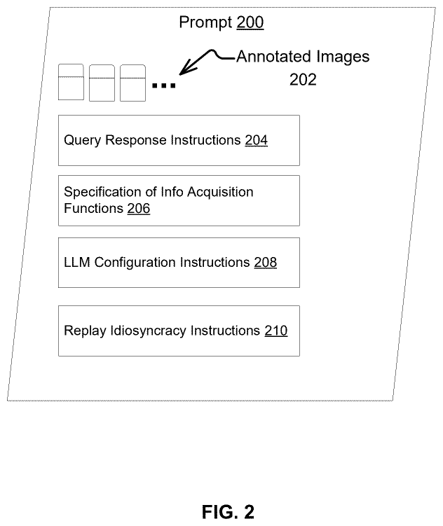

FIG. 2 illustrates a block diagram of a prompt 200 used in the software application session understanding system 100, according to some embodiments of the technology described herein. The prompt 200 includes several components that are provided as input to the LLM 108A for processing session information. The prompt 200 includes annotated images 202, which comprise a series of images captured from software application sessions combined with textual annotations describing user activity. The prompt 200 further includes query response instructions 204, which provide guidance to the LLM 108A on how to formulate responses to queries about the software application sessions. The prompt 200 also includes a specification of info acquisition functions 206, which defines the available tools or functions that the LLM 108A can invoke to obtain additional information during processing. These info acquisition functions may include tools to retrieve metadata about sessions, network requests, and responses, and console log entries. The prompt 200 additionally includes LLM configuration instructions 208, which provide parameters for how the LLM 108A should be executed, such as the level of reasoning effort to apply during processing.

The prompt 200 further includes replay idiosyncrasy instructions 210, which inform the LLM 108A about expected behaviors or limitations in session replays that should not be interpreted as problems. The replay idiosyncrasy instructions 210 provide caveats for the LLM 108A to consider when analyzing the session content. For example, the replay idiosyncrasy instructions 210 may indicate that certain elements such as HTML canvas elements cannot be recorded and should be assumed to have loaded successfully if they appear blank. The replay idiosyncrasy instructions 210 may further indicate that placeholder text, such as lorem ipsum, appearing in input fields should not be interpreted as literal user input, and that certain visual artifacts in the replay are expected and do not indicate problems with the software application.

In some embodiments, the LLM processing module 108 may be configured to generate the prompt 200 by combining the annotated images 202 with the query response instructions 204, the specification of info acquisition functions 206, the LLM configuration instructions 208, and the replay idiosyncrasy instructions 210. The LLM processing module 108 may generate the prompt 200 to request the LLM 108A to output information about the software application session(s) requested by a query. For example, the prompt 200 may include a request such as “Summarize the user's experience. What did they do? What did they expect to happen? What happened instead?” The LLM 108A may process the prompt 200 and generate LLM output(s) 128 that respond to the request based on the annotated images 202 and the instructions provided in the prompt 200.

Referring to FIG. 2, the prompt 200 includes several components that are provided as input to the LLM 108A for processing session information. The annotated images 202 comprise a series of images captured from software application sessions. The annotated images 202 are represented as a sequence of image frames with an ellipsis indicating that multiple images may be included. The annotated images 202 provide visual representations of graphical user interface content displayed during the software application sessions, combined with textual annotations describing user activity at corresponding points in the sessions. As described above, the annotated images 202 combine the images of GUI content 122 with the image annotations 124 generated by the image annotation module 106.

With continued reference to FIG. 2, the prompt 200 includes the query response instructions 204, which provide guidance to the LLM 108A on how to formulate responses to queries about the software application sessions. The query response instructions 204 are contained within a designated section of the prompt 200. In some embodiments, the LLM processing module 108 may be configured to include, in the prompt 200, instructions to output the information about software application session(s) requested by the query. For example, the query response instructions 204 may specify that the LLM 108A should provide a natural language summary of user activity, describe problems encountered during the session, or respond to specific questions about the software application session(s). The query response instructions 204 may further specify formatting requirements for the LLM output(s) 128, such as including timestamps, citations to specific points in the session, or structured data fields.

As further shown in FIG. 2, the prompt 200 includes the specification of information acquisition functions 206, which defines the available tools or functions that the LLM 108A can invoke to obtain additional information during processing. In some embodiments, the LLM processing module 108 may be configured to include, in the prompt 200, a specification of function(s) that can be triggered for execution by the LLM 108A to obtain additional information. The specification of info acquisition functions 206 may define functions such as a tool to get metadata about a session, a tool or function to get network requests and responses between specified times, and a tool or function to get information that was logged to a console between specified times. For example, if an error occurred during the session, the LLM 108A may request more information by invoking one of the functions specified in the specification of info acquisition functions 206. Providing all available data at the onset would result in too much information, which may be expensive and may reduce the quality of output. The specification of info acquisition functions 206 allows the LLM 108A to selectively request additional information as needed during processing.

The prompt 200 additionally includes the LLM configuration instructions 208, which provide parameters for how the LLM 108A should be executed. In some embodiments, the LLM processing module 108 may be configured to include, in the prompt 200, information that configures the operation of the LLM 108A. The LLM configuration instructions 208 may specify aspects such as the level of reasoning effort to apply during processing. For example, the LLM configuration instructions 208 may specify how much effort to put into reasoning to achieve efficiency targets such as processing under 3 minutes. In some embodiments, the LLM processing module 108 may implement logic that degrades performance if a request is taking too long, based on parameters specified in the LLM configuration instructions 208. The LLM configuration instructions 208 allow the system 100 to balance processing quality against computational cost and response time requirements.

The prompt 200 further includes replay idiosyncrasy instructions 210, which inform the LLM 108A about expected behaviors or limitations in session replays that should not be interpreted as problems. The replay idiosyncrasy instructions 210 provide caveats for the LLM 108A to consider when analyzing the session content. For example, the replay idiosyncrasy instructions 210 may indicate that certain elements, such as HTML canvas elements cannot be recorded and should be assumed to have loaded successfully if they appear blank in the session replay 120A or the session replay 120B. The replay idiosyncrasy instructions 210 may further indicate that placeholder text, such as lorem ipsum appearing in input fields should not be interpreted as literal user input, that certain visual artifacts in the replay are expected and do not indicate problems with the software application, and that the replay may not 100% reflect the exact original session. The replay idiosyncrasy instructions 210 include a list of items specifying these caveats, which allows the LLM 108A to distinguish between actual problems in the software application and expected limitations of the session replay process.

FIG. 3 illustrates a sequence diagram representing an interaction process between the LLM processing module 108 and the LLM 108A, according to some embodiments of the technology described herein. As shown in FIG. 3, the process begins with the LLM processing module 108 sending a prompt 300 to the LLM 108A. The prompt 300 may include the annotated images 202, the query response instructions 204, the specification of info acquisition functions 206, and the LLM configuration instructions 208 as described above with respect to FIG. 2. In response to the prompt 300, the LLM 108A may send an information acquisition function trigger 302 back to the LLM processing module 108. The information acquisition function trigger 302 indicates that the LLM 108A requests additional information to process the prompt 300. In some embodiments, the LLM processing module 108 may be configured to receive, from the LLM 108A, a request to execute a first function of the info acquisition function(s) 108B.

With continued reference to FIG. 3, upon receiving the info acquisition function trigger 302, the LLM processing module 108 executes one or more of the info acquisition function(s) 108B to obtain the requested information. The LLM processing module 108 may be configured to execute the function(s) in response to the request to generate set(s) of information. The LLM processing module 108 then sends info from function execution 304 to the LLM 108A, providing the set(s) of information obtained from executing the information acquisition function(s) 108B.

As further shown in FIG. 3, after receiving the info from function execution 304, the LLM 108A processes the first set of information generated from execution of the first function to generate the LLM output. The LLM 108A generates a query response 306, which is sent back to the LLM processing module 108. The sequence diagram of FIG. 3 illustrates a loop where the LLM 108A can dynamically request additional information through the info acquisition function trigger 302, and the LLM processing module 108 can provide that information through the info from function execution 304 before the LLM 108A generates the final query response 306. This interaction pattern allows the LLM 108A to selectively acquire information as needed rather than receiving all available data at the onset. Providing all available data at the onset would result in too much information, which may be expensive in terms of computational resources and may reduce the quality of output. The selective acquisition approach reduces expense and improves output quality by allowing the LLM 108A to focus on information that is relevant to a particular request.

Referring again to FIG. 3, the information acquisition function(s) 108B may include various types of functions that the LLM 108A can trigger for execution. For example, the information acquisition function(s) 108B may include a metadata acquisition function that, when executed, obtains metadata about the software application session(s). The metadata acquisition function may be configured to retrieve session metadata such as session identifiers, user identifiers, timestamps, device information, and other contextual information about the software application session.

In some embodiments, the information acquisition function(s) 108B may include a network information acquisition function that, when executed, obtains information about network requests and/or responses at point(s) in software application session(s). The network information acquisition function may be configured to retrieve network requests and responses between specified times. For example, the LLM 108A may request network information for a time range corresponding to a period when an error occurred in the software application session. The network information returned by the info acquisition function(s) 108B may include structured data, including request and response details with headers, body content, timestamps, and duration information. For example, the returned information may include the request URL, HTTP method, request headers, request body, response status code, response headers, response body, and duration in milliseconds. The network information returned by the info acquisition function(s) 108B may further include gRPC-specific information, such as grpc-status and grpc-message headers for error diagnosis. For example, when a network request results in an error, the grpc-message header may contain error details such as an error identifier, error information, and developer information that the LLM 108A can use to understand the cause of the error.

In some embodiments, the information acquisition function(s) 108B may include a log information acquisition function that, when executed, obtains information about messages logged to a console at point(s) in the software application session(s). The log information acquisition function may be configured to retrieve information that was logged to a console between specified times. For example, the LLM 108A may request console log entries for a time range corresponding to a period when an error occurred, allowing the LLM 108A to examine error messages, warnings, or other diagnostic information that was logged during that period.

It should be appreciated that some embodiments may be configured to implement other types of information acquisition functions in addition to or instead of those described herein.

With continued reference to FIG. 3, the iterative interaction between the LLM processing module 108 and the LLM 108A allows the LLM 108A to dynamically choose additional information during processing. The LLM 108A may send multiple info acquisition function triggers 302 during a single processing session, with the LLM processing module 108 executing the corresponding info acquisition function(s) 108B and returning the info from function execution 304 for each request. This process continues in a loop until the LLM 108A has obtained sufficient information to generate the query response 306. The query response 306 may include a text field containing natural language content responding to the query and a separate field that includes an array of citations supporting the content of the text field. These citations may be evidence points from the sessions that support statements made in the query response 306.

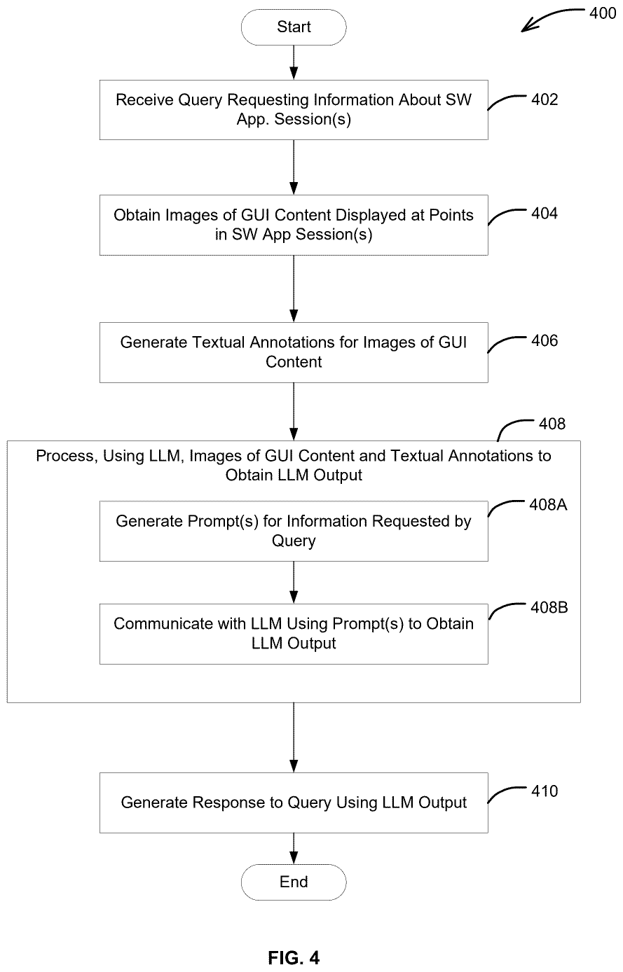

FIG. 4 illustrates a flowchart for an example process 400 for responding to queries requesting information about software application sessions, according to some embodiments of the technology described herein. The process 400 begins at a Start node and proceeds through a series of blocks that implement the session understanding techniques described above with respect to FIGS. 1A, 1B, 2, and 3. In some embodiments, the process 400 may be performed by the software application session understanding system 100 described herein with reference to FIGS. 1A-1B.

Referring to FIG. 4, the process 400 proceeds to a block 402, where the system receives a query requesting information about software application sessions. In some embodiments, receiving the query requesting information about the software application session(s) may comprise receiving a query requesting a summary of user activity in the software application session(s). For example, the query may request a summary of what a user did during a session, what the user expected to happen, and what happened instead. For example, the query may be received from external system(s) 114 through a communication network, as described above with respect to FIG. 1A. In some embodiments, the query may request other types of information about the software application sessions, such as descriptions of problems that occurred, information about specific functionality, or portions of sessions that meet specified conditions.

With continued reference to FIG. 4, the process 400 proceeds to a block 404, where images of GUI content displayed at points in the software application sessions are obtained. As described above with respect to FIG. 1B, the session image capture module 104 may generate the session replay 120A and the session replay 120B and capture the images of GUI content 122 from the session replays. In some embodiments, obtaining the images of GUI content displayed at the points in software application session(s) may comprise obtaining images of GUI content displayed at points in the software application session(s) when user actions are being performed in the GUI. As described above, the session image capture module 104 may identify periods of user activity in the software application sessions and sample images during those periods when user actions such as clicks, touch interactions, or navigation events are occurring. This approach focuses the captured images on portions of the sessions that are most likely to contain relevant information about the user's experience.

As further shown in FIG. 4, the process 400 proceeds to a block 406, where textual annotations are generated for the images of GUI content. As described above with respect to FIG. 1B, the image annotation module 106 may generate the image annotations 124 for the images of GUI content 122. For example, the image annotations 124 may include textual descriptions of user actions being performed at corresponding points in the software application sessions, such as descriptions of elements being clicked, navigation events, and text displayed to the user.

Referring again to FIG. 4, the process 400 proceeds to a block 408, which encompasses processing using the LLM 108A to obtain the LLM output(s) 128 from the images of GUI content 122 and the image annotations 124. Within the block 408, a block 408A involves generating prompts for information requested by the query. As described above with respect to FIG. 2, the prompt 200 may include the annotated images 202, the query response instructions 204, the specification of info acquisition functions 206, and the LLM configuration instructions 208. The prompt(s) 126 may include the annotated images 126A combining the images with the textual annotations and the instructions 126B providing directives for the LLM 108A.

With continued reference to FIG. 4, within the block 408, a block 408B involves communicating with the LLM 108A using the prompts to obtain the LLM output(s) 128. In some embodiments, communicating with the LLM 108A using the prompt(s) to obtain the LLM output may comprise communicating with the LLM 108A to obtain a natural language summary of the user activity in the software application session(s). As described above with respect to FIG. 3, the communication with the LLM 108A may involve an iterative process where the LLM 108A can request additional information through the info acquisition function(s) 108B before generating the final output. The LLM output(s) 128 may include natural language summaries describing what the user did, what the user expected to happen, and what happened instead.

As further shown in FIG. 4, the process 400 proceeds to a block 410, where the system generates a response to the query using the LLM output(s) 128. In some embodiments, the response may include the natural language summary generated by the LLM 108A along with citations to specific points in the session data that support the generated content. As described above, the response may include links that navigate to particular points in the session replay 120A or the session replay 120B, allowing users to verify the accuracy of the generated information against the underlying session data. The process 400 then concludes at an End node.

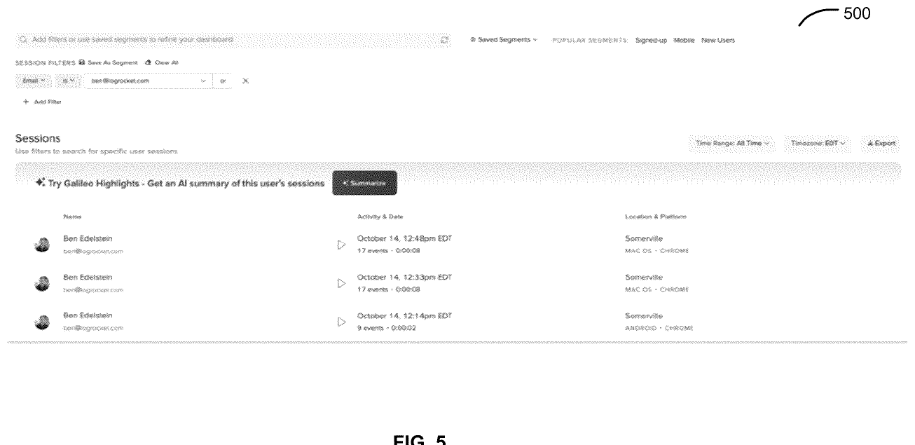

FIG. 5 illustrates a session list interface 500 for searching and filtering user sessions, according to some embodiments of the technology described herein. The session list interface 500 provides a graphical user interface through which users may search for, filter, and view software application sessions. In some embodiments, the session list interface 500 may be provided by the software application session understanding system 100 described herein with reference to FIGS. 1A-1B (e.g., to the external system(s) 114) to allow users to access session data and request summaries of user activity.

Referring to FIG. 5, the session list interface 500 includes a search bar at the top of the interface for adding filters or using saved segments to refine a dashboard. The search bar may provide options for saved segments and popular segments, including signed-up, mobile, and new users. Below the search bar, the session list interface 500 displays session filters with options to save as a segment or clear all filters. The session filters may include an email filter that allows users to filter sessions by a specific email address. The session list interface 500 further includes time range and time zone selectors that allow users to specify a time period for which to display sessions, along with an export option for exporting session data.

With continued reference to FIG. 5, the session list interface 500 includes a section that invites users to generate an AI summary feature for the displayed user's sessions. The section includes a summarize button that, when selected, may invoke the software application session understanding system 100 to generate summaries of the displayed sessions using the techniques described herein (e.g., by transmitting a query to the system 100). For example, selecting the summarize button may cause the system 100 to obtain the images of GUI content 122 from session replays, generate the image annotations 124, and process the annotated images using the LLM 108A to generate the LLM output(s) 128 containing natural language summaries of the sessions.

As further shown in FIG. 5, the session list interface 500 presents a sessions table listing multiple sessions with columns for name, activity, date, and location and platform. Each row in the sessions table displays a user's name and email, a play button for viewing the session replay, a session timestamp indicating when the session occurred, an event count indicating the number of events in the session, a duration indicating the length of the session, and location information, including operating system and browser type. The sessions shown in the session list interface 500 may be from the same user and may display various dates, event counts, and platform combinations, including MAC OS with CHROME and ANDROID with CHROME, with locations shown for each session. The session list interface 500 allows users to select individual sessions for viewing or to request summaries of multiple sessions using the AI summary feature.

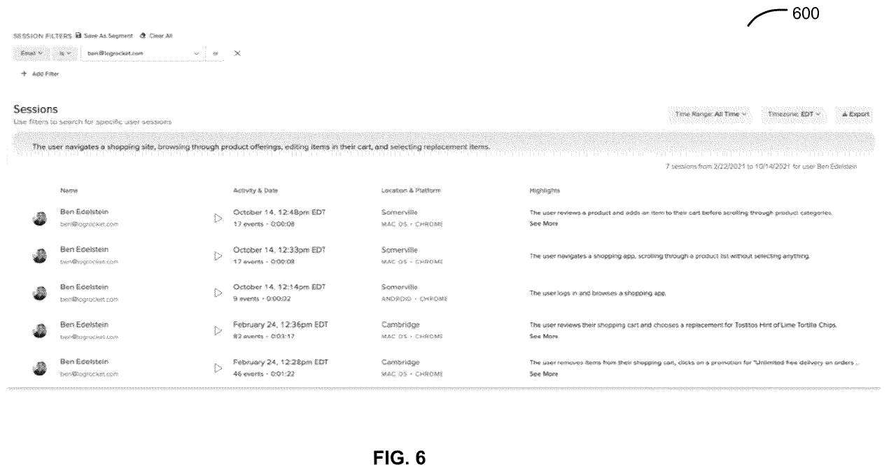

FIG. 6 illustrates a session list interface 600 displaying sessions with natural language summaries, according to some embodiments of the technology described herein. The session list interface 600 provides a graphical user interface through which users may view software application sessions along with generated summaries of user activity. In some embodiments, the session list interface 600 may be provided by the software application session understanding system 100 described herein with reference to FIGS. 1A-1B to display information generated from the LLM output(s) 128 generated by the LLM 108A.

Referring to FIG. 6, the session list interface 600 displays session filters at the top of the interface, including an email filter set to a specific email address. The session list interface 600 includes an overall summary statement that describes user activity across multiple sessions. For example, the overall summary statement may indicate that the user navigates a shopping site, browsing through product offerings, editing items in their cart, and selecting replacement items. The overall summary statement provides a high-level description of the user's activity across the sessions displayed in the session list interface 600, allowing users to understand the user's experience without reviewing each individual session.

With continued reference to FIG. 6, the session list interface 600 shows a list of sessions from a date range for a particular user. Each session entry within the session list interface 600 displays details such as the number of events, duration, operating system, browser type, and a natural language description of user activity during that session. For example, a session entry may include a natural language description such as “The user reviews a product and adds an item to their cart before scrolling through product categories” or “The user reviews their shopping cart and chooses a replacement for Tostitos Hint of Lime Tortilla Chips.” Some session entries may include a “See More” option for viewing additional information about the session.

As further shown in FIG. 6, the session list interface 600 displays natural language descriptions that include embedded links navigating to particular points in session replays. As described above with respect to FIG. 3, the query response 306 generated by the LLM 108A may include a structured output containing a text field with natural language content responding to the query and a separate field containing an array of citations that provide evidence points from the sessions supporting statements in the text field. In some embodiments, generating the response to the query using the LLM output may comprise obtaining, from the LLM output, a set of text to include in the response to the query and embedding, in the set of output text, link(s) that each navigate to a particular point in replay(s) of the software application session(s). The citations in the query response 306 may be used to embed links and in-line screenshots in the summary content to provide trust and transparency to clients. For example, text within the natural language descriptions may be displayed as selectable links that, when selected, navigate to the corresponding point in the session replay 120A or the session replay 120B where the described activity occurred. This allows users to verify the accuracy of the generated summaries by viewing the underlying session data at the cited points.

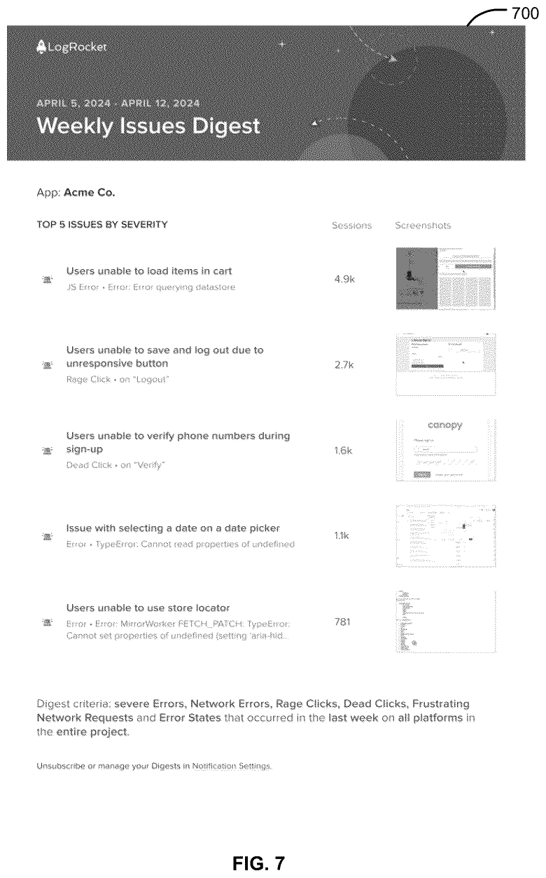

FIG. 7 illustrates a weekly issues digest interface 700 displaying top issues by severity, according to some embodiments of the technology described herein. The weekly issues digest interface 700 provides a graphical user interface through which users may view a summary of issues identified across software application sessions during a specified time period. In some embodiments, the weekly issues digest interface 700 may be provided by the software application session understanding system 100 described herein with reference to FIGS. 1A-1B to present issue triage results generated using the LLM 108A.

Referring to FIG. 7, the weekly issues digest interface 700 displays a header indicating a date range for the digest, such as a week-long period, along with a title identifying the interface as a weekly issues digest. The weekly issues digest interface 700 further displays an application identifier that specifies the software application for which the issues have been identified. Below the header, the weekly issues digest interface 700 presents a table titled “TOP 5 ISSUES BY SEVERITY” with columns for issue descriptions, session counts, and images.

With continued reference to FIG. 7, each row in the table of the weekly issues digest interface 700 displays an issue entry containing a natural language description of the issue, an associated issue type, a count of sessions in which the issue occurred, and a screenshot thumbnail providing visual context for the issue. For example, issue entries may include natural language descriptions such as “Users unable to load items in cart” associated with a JavaScript error, “Users unable to save and log out due to unresponsive button” associated with a rage click event, “Users unable to verify phone numbers during sign-up” associated with a dead click event, “Issue with selecting a date on a date picker” associated with a type error, and “Users unable to use store locator” associated with an error. The session counts displayed in the weekly issues digest interface 700 indicate the number of sessions affected by each issue, allowing users to assess the scope of impact for each identified issue.

As further shown in FIG. 7, the weekly issues digest interface 700 includes digest criteria text at the bottom of the interface indicating the types of issues covered by the digest. The digest criteria may specify that the digest covers severe errors, network errors, rage clicks, dead clicks, frustrating network requests, and error states that occurred during the specified time period across all platforms in the project. The weekly issues digest interface 700 may further include an option to unsubscribe or manage digest settings in notification settings.

In some embodiments, the software application session understanding system 100 may be configured to perform issue triage by analyzing points in software application sessions that may be problematic. The system 100 may identify points in a session where issues such as errors, rage clicks, dead clicks, or frustrating network requests occurred. The system 100 may provide the identified points to the LLM processing module 108 to obtain triage output that includes natural language descriptions of the issues and assessments of issue severity. The system 100 may be configured to use the LLM 108A to analyze the session context at problematic points and generate natural language descriptions that explain the issue and its impact on users.

In some embodiments, the software application session understanding system 100 may be configured to integrate with issue trackers to obtain changes and use that information to inform session analysis. The system 100 may be configured to receive information from an issue tracker indicating changes such as new issues, resolved issues, or updates to issue status. The system 100 may be configured to use the information obtained from the issue tracker as additional context when analyzing software application sessions. For example, when generating the LLM output(s) 128, the LLM 108A may consider information from the issue tracker to correlate session activity with known issues or to identify sessions that may be related to recently reported problems. This integration allows the system 100 to provide more relevant and actionable information in the weekly issues digest interface 700 by connecting session analysis with issue tracking workflows.

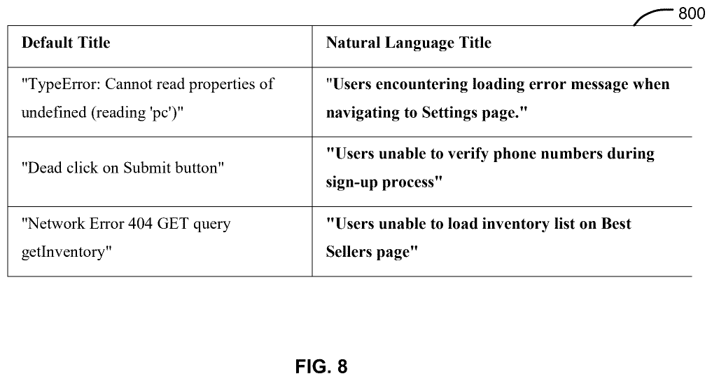

FIG. 8 illustrates an error title translation table 800 that shows conversion of technical error titles into natural language titles, according to some embodiments of the technology described herein. The error title translation table 800 provides examples of how the software application session understanding system 100 may be configured to transform default technical error messages into human-readable descriptions that convey the impact of issues on user experience.

Referring to FIG. 8, the error title translation table 800 contains two columns. A left column is labeled “Default Title” and contains technical error messages as they may appear in software application logs or error reports. A right column is labeled “Natural Language Title” and contains corresponding natural language descriptions that describe the user-facing impact of each error. The error title translation table 800 includes three rows of example translations that demonstrate the transformation from technical terminology to user-understandable descriptions. With continued reference to FIG. 8, a first row of the error title translation table 800 shows a default title of “TypeError: Cannot read properties of undefined (reading ‘pc’)” translated to a natural language title of “Users encountering loading error message when navigating to Settings page.” A second row shows a default title of “Dead click on Submit button” translated to a natural language title of “Users unable to verify phone numbers during sign-up process.” A third row shows a default title of “Network Error 404 GET query getInventory” translated to a natural language title of “Users unable to load inventory list on Best Sellers page.”

In some embodiments, the software application session understanding system 100 may be configured to use the LLM 108A to create natural language descriptions of issues identified in software application sessions. The system 100 may be configured to ingest session events to analyze sessions and identify patterns in user behavior. The system 100 may be configured to process information about what is happening in those sessions and distill the information into descriptions of issues that are causing users to struggle. The LLM 108A may receive technical error information, such as error types, error messages, and contextual information about where and when errors occurred in the software application sessions. The LLM 108A may process the technical error information along with the images of GUI content 122 and the image annotations 124 to generate natural language descriptions that explain the user-facing impact of each error.

In some embodiments, the natural language descriptions generated by the LLM 108A may allow users, regardless of technical experience, to assess the impact of issues on user experience and to prioritize the resolution of issues. For example, a technical error message such as “TypeError: Cannot read properties of undefined (reading ‘pc’)” may not convey meaningful information to a non-technical user about what problem users are experiencing. The corresponding natural language title “Users encountering loading error message when navigating to Settings page” describes the user-facing symptom of the error in terms that allow anyone to understand the impact on user experience. This transformation enables product managers, customer support representatives, and other non-technical stakeholders to assess issue severity and prioritize resolution without requiring detailed technical knowledge of the underlying error types.

In some embodiments, the system 100 may be configured to generate natural language titles for various types of issues including JavaScript errors, dead clicks, rage clicks, network errors, and other issue types. The system 100 may be configured to analyze the context in which each issue occurred, including the page or screen where the issue appeared, the user action that triggered the issue, and the resulting impact on the user's ability to complete tasks. The LLM 108A may use this contextual information to generate natural language titles that describe both the symptom experienced by users and the functional impact of the issue. For example, the natural language title “Users unable to verify phone numbers during sign-up process” describes both the user action that failed (verifying phone numbers) and the workflow context (sign-up process), providing actionable information for prioritizing and resolving the issue.

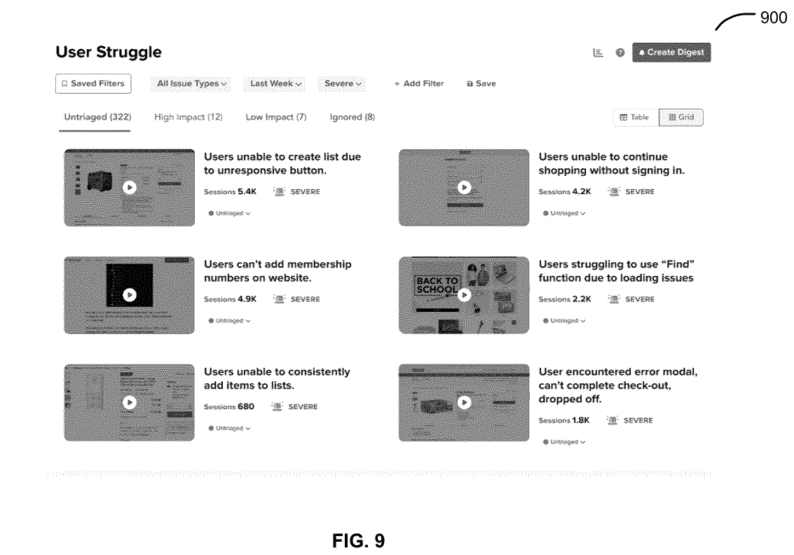

FIG. 9 illustrates a GUI 900 for displaying and triaging user struggle issues, according to some embodiments of the technology described herein. The interface 900 provides a graphical user interface through which users may view, filter, and triage issues that have been identified as causing user struggle in software application sessions. In some embodiments, GUI 900 may be provided by the software application session understanding system 100 described herein with reference to FIGS. 1A-1B to present issues identified through analysis of the images of GUI content 122 and the image annotations 124 using the LLM 108A.

Referring to FIG. 9, the GUI 900 displays filtering options at the top of the interface that allow users to refine the displayed issues. The filtering options may include saved filters, issue type filters, time range filters, and severity filters. For example, the GUI 900 may include options to filter by “All Issue Types,” “Last Week,” and “Severe” severity level, along with options to add additional filters and save filter configurations. The filtering options allow users to focus on specific subsets of issues based on criteria such as issue type, time period, and severity level. With continued reference to FIG. 9, the GUI 900 includes categorization tabs that allow users to view issues organized by triage status. The categorization tabs may include tabs for “Untriaged,” “High Impact,” “Low Impact,” and “Ignored” issues, with each tab displaying a count of issues in that category. For example, the categorization tabs may display counts such as “Untriaged (322),” “High Impact (12),” “Low Impact (7),” and “Ignored (8).” The categorization tabs allow users to navigate between different triage categories and to track progress in triaging identified issues. The GUI 900 may further include viewing options for displaying issues in “Table” or “Grid” layouts.

As further shown in FIG. 9, the GUI 900 presents issue cards arranged in a grid format. Each issue card within the GUI 900 contains several elements that provide information about the identified issue. Each issue card includes a thumbnail image with a play button that allows users to view the session replay 120A or the session replay 120B at the point where the issue occurred. Each issue card further includes a natural language description of the user struggle that describes the issue in terms of its impact on user experience. For example, natural language descriptions displayed in the issue cards may include descriptions such as “Users unable to create list due to unresponsive button,” “Users unable to continue shopping without signing in,” “Users can't add membership numbers on website,” “Users struggling to use ‘Find’ function due to loading issues,” “Users unable to consistently add items to lists,” and “User encountered error modal, can't complete check-out, dropped off.” Each issue card in the user struggle interface 900 further includes a session count indicating the number of sessions in which the issue occurred. For example, session counts displayed in the issue cards may include values such as “5.4K sessions,” “4.2K sessions,” “4.9K sessions,” “2.2K sessions,” “680 sessions,” and “1.8K sessions.” The session counts allow users to assess the scope of impact for each identified issue and to prioritize issues that affect larger numbers of users. Each issue card in the user struggle interface 900 additionally includes a severity indicator that indicates the severity level of the issue. For example, the severity indicator may display a label such as “SEVERE” to indicate that the issue has been classified as a severe user struggle issue. The severity indicators allow users to identify issues that may have the greatest impact on user experience. Each issue card may further include a triage status indicator, such as “Untriaged,” that indicates the current triage status of the issue.

In some embodiments, the GUI 900 may include a “Create Digest” button that allows users to generate a digest of the displayed issues. The digest may be similar to the weekly issues digest displayed in the weekly issues digest interface 700 described above with respect to FIG. 7. The GUI 900 allows users to triage issues by categorizing issues as high impact, low impact, or ignored based on assessment of the issue severity and user impact. The triage actions performed through the GUI 900 may be used by the software application session understanding system 100 to improve future issue identification and prioritization.

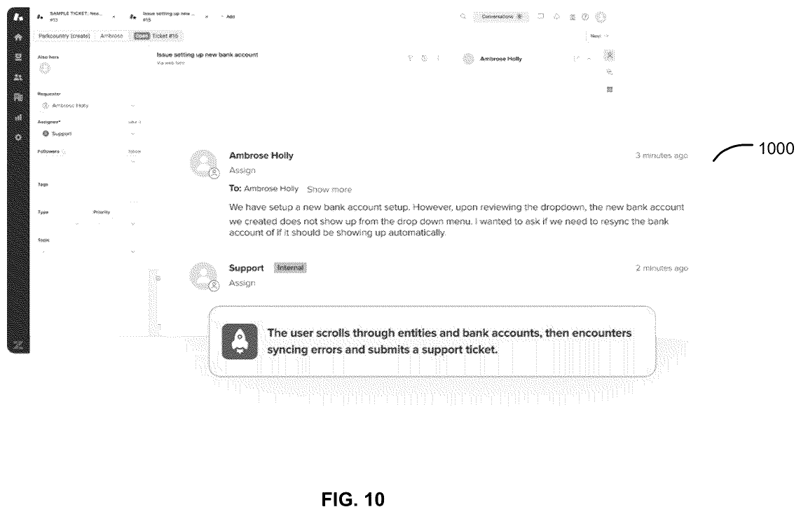

FIG. 10 illustrates a GUI 1000 displaying session context for support requests, according to some embodiments of the technology described herein. The GUI 1000 (also referred to herein as “the support ticket interface 1000”) provides a graphical user interface through which support personnel may view support tickets along with contextual information about user activity leading up to the support request. In some embodiments, the support ticket interface 1000 may be provided by the software application session understanding system 100 described herein with reference to FIGS. 1A-1B to present information generated from the LLM output(s) 128 in the context of a ticketing system.

Referring to FIG. 10, the support ticket interface 1000 displays multiple tabs at the top of the interface that allow navigation between different support tickets. The support ticket interface 1000 includes ticket metadata fields on the left side of the interface that display information about the support ticket. The ticket metadata fields may include a requester field identifying the user who submitted the ticket, an assignee field indicating the support team or individual assigned to handle the ticket, a followers field, a tags field, a type field, a priority field, and a topic field. The ticket metadata fields allow support personnel to view and manage ticket attributes and to track ticket status and assignment. With continued reference to FIG. 10, the support ticket interface 1000 includes a main content area that displays the ticket subject and a conversation thread. The ticket subject may indicate the nature of the support request, such as “Issue setting up new bank account.” The conversation thread displays messages exchanged between the user and support personnel, with each message displaying a timestamp indicating when the message was submitted. For example, the conversation thread may display a message from the user describing the issue, such as a message indicating that a new bank account was set up but does not appear in a dropdown menu, and asking whether the bank account needs to be resynced or should appear automatically.

As further shown in FIG. 10, the support ticket interface 1000 includes a graphical element that contains a natural language summary of user activity leading up to the support request. The graphical element may be displayed as an internal note within the conversation thread that is visible to support personnel but not to the end user who submitted the ticket. The graphical element may contain a summary generated by the LLM 108A based on analysis of the session replay 120A or the session replay 120B associated with the user who submitted the support request. For example, the graphical element may contain a summary such as “the user scrolls through entities and bank accounts, then encounters syncing errors and submits a support ticket.” The graphical element provides support personnel with immediate context about what the user experienced before submitting the support request, allowing support personnel to understand and reproduce the issue without manually reviewing the entire session.

In some embodiments, the software application session understanding system 100 may be configured to generate the natural language summary displayed in the graphical element by processing a query that is driven by a request for specific information. The query may include a user's description of an issue submitted to a ticketing system, such as the message content from the support ticket displayed in the support ticket interface 1000. The system 100 may use the user's description of the issue as additional context when generating the prompt(s) 126 for the LLM 108A. For example, the query response instructions 204 in the prompt 200 may include the user's description of the issue, along with instructions for the LLM 108A to summarize user activity that is relevant to the described issue. The LLM 108A may process the images of GUI content 122 and the image annotations 124 in light of the user's description to generate a summary that is tailored to the user's complaint with links that pinpoint relevant moments in the user's session(s).

In some embodiments, the software application session understanding system 100 may be configured to integrate with a ticketing system to automatically generate and post the graphical element when a support ticket is submitted. The system 100 may receive notification that a support ticket has been submitted by a user and may retrieve session data associated with that user from the datastore 110. The session image capture module 104 may generate the session replay 120A from the retrieved session data and capture the images of GUI content 122. The image annotation module 106 may generate the image annotations 124 for the captured images. The LLM processing module 108 may generate the prompt(s) 126 including the annotated images 126A, the instructions 126B, and the user's description of the issue from the support ticket. The LLM 108A may process the prompt(s) 126 to generate the LLM output(s) 128 containing a natural language summary of user activity leading up to the support request. The system 100 may then post the generated summary as an internal note in the support ticket interface 1000.

In some embodiments, the graphical element displayed in the support ticket interface 1000 may include links that navigate to particular points in the session replay 120A where relevant activity occurred. As described above with respect to FIG. 6, the LLM output(s) 128 may include citations to specific points in the session data that support statements made in the generated summary. The system 100 may embed links in the graphical element that, when selected, navigate to the corresponding points in the session replay 120A, allowing support personnel to view the underlying session data at the cited points. The graphical element may further include images that provide visual context for the summarized activity, allowing support personnel to grasp the situation without viewing the entire session.

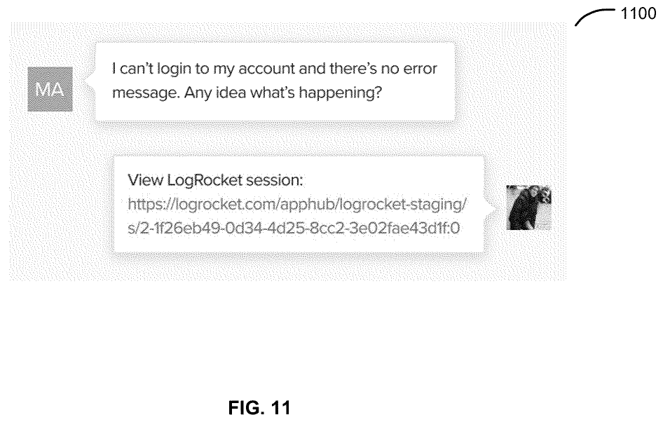

FIG. 11 illustrates a chat interface 1100 providing session information in response to user support inquiries, according to some embodiments of the technology described herein. The chat interface 1100 provides a graphical user interface through which users may submit support inquiries and receive responses that include links to relevant session data. In some embodiments, the chat interface 1100 may be provided by the software application session understanding system 100 described herein with reference to FIGS. 1A-1B to present session information in the context of a support conversation.

Referring to FIG. 11, the chat interface 1100 displays a conversation between a user and a support system. The chat interface 1100 includes a user message displayed in a speech bubble that contains the user's support inquiry. For example, the user message may contain text such as “I can't login to my account and there's no error message. Any idea what's happening?” The user message describes an issue that the user is experiencing with the software application, in this case a login issue where no error message is displayed to indicate the cause of the problem.

With continued reference to FIG. 11, the chat interface 1100 displays a response below the user message that contains session information relevant to the user's inquiry. The response includes text that reads “View LogRocket session:” followed by a URL link that provides access to the user's session data. The URL link may navigate to a session replay viewer where support personnel or the user may view the session replay 120A associated with the user's activity leading up to the support inquiry. The response further includes a thumbnail screenshot that provides a visual representation of a frame from the user's session. The thumbnail screenshot allows users or support personnel to view a preview of the session content without navigating to the full session replay.

In some embodiments, the software application session understanding system 100 may be configured to generate the response displayed in the chat interface 1100 by processing the user's support inquiry as a query requesting information about the user's software application session(s). The system 100 may retrieve session data associated with the user from the datastore 110 and generate the session replay 120A from the retrieved session data. The session image capture module 104 may capture the images of GUI content 122 from the session replay 120A, and the image annotation module 106 may generate the image annotations 124 for the captured images. The LLM processing module 108 may generate the prompt(s) 126 including the annotated images 126A and the instructions 126B, along with the user's description of the issue from the chat message. The LLM 108A may process the prompt(s) 126 to generate the LLM output(s) 128 containing information about the user's session that is relevant to the described issue.

In some embodiments, the chat interface 1100 may be configured to automatically provide the session URL link and thumbnail screenshot in response to a user support inquiry without requiring manual intervention by support personnel. The system 100 may detect that a support inquiry has been submitted through the chat interface 1100 and may automatically retrieve and process the user's session data to generate the response. The response may be posted as a message in the chat interface 1100 that is visible to support personnel and, in some embodiments, to the user who submitted the inquiry. The automatic provision of session links and thumbnails allows support personnel to access relevant session context without manually searching for the user's sessions.

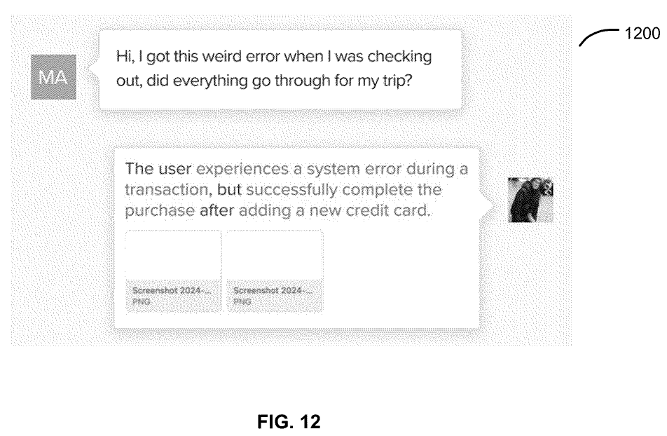

FIG. 12 illustrates a chat interface 1200 displaying a summary of a user's software application session experience with visual evidence, according to some embodiments of the technology described herein. The chat interface 1200 provides a graphical user interface through which users may submit support inquiries and receive responses that include natural language summaries along with images that provide visual evidence supporting the summary content. In some embodiments, the chat interface 1200 may be provided by the software application session understanding system 100 described herein with reference to FIGS. 1A-1B to present session summaries with supporting visual evidence in the context of a support conversation.

Referring to FIG. 12, the chat interface 1200 displays a conversation that includes a user message from a user asking about an error encountered during checkout and whether a transaction completed successfully. For example, the user message may contain text inquiring about a weird error encountered during checkout and asking whether everything went through for a trip. The user message describes uncertainty about whether a transaction completed despite encountering an error during the checkout process. With continued reference to FIG. 12, the chat interface 1200 displays a response below the user message that includes a natural language summary stating outcomes of the user's session activity. The natural language summary may indicate that the user experienced a system error during a transaction but successfully completed the purchase after adding a new credit card. The natural language summary describes both the problem encountered by the user (the system error) and the outcome of the user's actions (successful completion of the purchase), providing the user with a clear understanding of what occurred during the session.

As further shown in FIG. 12, the response in the chat interface 1200 includes images (e.g., screenshot thumbnails) that provide visual evidence supporting the natural language summary. The images may be labeled with filenames indicating that the thumbnails are screenshot images captured from the user's session. The images allow users or support personnel to view visual representations of frames from the session that correspond to the events described in the natural language summary. For example, the images may show the error state encountered during checkout and the successful completion screen after the user added a new credit card. The inclusion of images provides visual evidence that supports the statements made in the natural language summary, allowing users to verify the accuracy of the summary against the underlying session data.

In some embodiments, the LLM output(s) 128 generated by the LLM 108A may include sections containing the model's reasoning process for analyzing sequences of events in the software application session(s). The sections may contain the LLM 108A's internal reasoning as the model processes the images of GUI content 122 and the image annotations 124 to understand what occurred during the session. For example, the sections may include reasoning about pinpointing culprits when analyzing error conditions, such as identifying the sequence of user actions that led to an error and determining the root cause of the problem. The sections may further include reasoning about analyzing sequences of events to understand the relationship between user actions and system responses, such as determining that a user selected a particular option, then a facility, resulting in a database constraint error.

In some embodiments, the sections in the LLM output(s) 128 may contain reasoning that focuses on the sequence of events leading to problems identified in the session. For example, the sections may include reasoning such as identifying that a user's current thinking focuses on the sequence of events where the user selected a purchase order, then a facility, resulting in a database constraint error, and that attempting a different facility triggered a front-end validation. The sections may further include reasoning that the initial error points to a back-end issue involving sequence number assignments and that this warrants deeper inspection of the database schema and related code. The sections allow the LLM 108A to document the reasoning process used to arrive at conclusions stated in the natural language summary, providing transparency into how the model analyzed the session data.

In some embodiments, the software application session understanding system 100 may be configured to use the sections from the LLM output(s) 128 to generate more accurate and detailed summaries of user activity. The reasoning process documented in the sections may inform the natural language summary by providing a structured analysis of the events that occurred during the session. For example, when the LLM 108A reasons about pinpointing the source of an error, the resulting natural language summary may include a description of the specific actions that led to the error and the outcome of those actions. The sections may be used internally by the system 100 to improve the quality of the generated summaries without being directly displayed to users in the chat interface 1200.

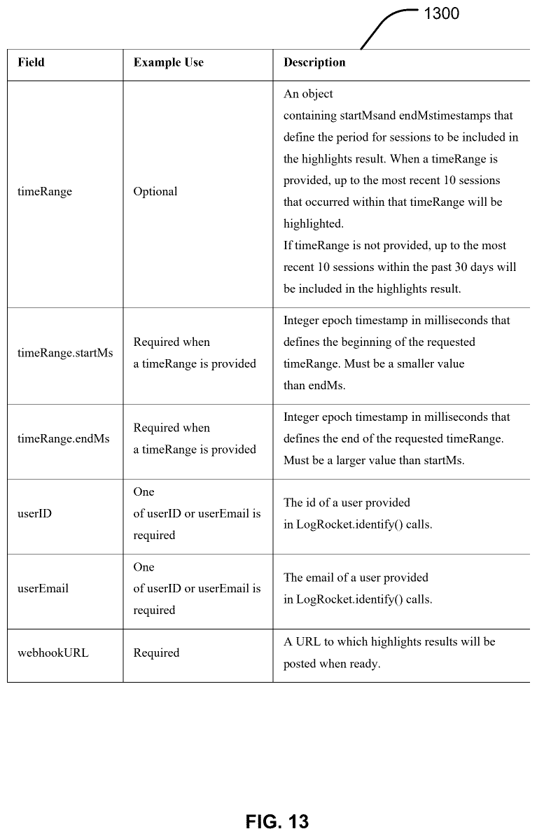

FIG. 13 illustrates a request fields table 1300 specifying parameters for requesting session summaries, according to some embodiments of the technology described herein. The request fields table 1300 defines the fields that may be included in requests submitted to the software application session understanding system 100 to obtain summaries of software application sessions. In some embodiments, the request fields table 1300 may specify parameters for requests received through an application programming interface (API) exposed by the system 100.

Referring to FIG. 13, the request fields table 1300 includes columns for Field, Example Use, and Description. The request fields table 1300 defines a timeRange field as optional. The timeRange field is an object containing startMs and endMs timestamps that define the period for sessions to be included in highlights results. When a timeRange is provided, up to the most recent 10 sessions that occurred within that timeRange may be highlighted. If timeRange is not provided, up to the most recent 10 sessions within the past 30 days may be included in the highlights result.

With continued reference to FIG. 13, the request fields table 1300 specifies a timeRange. startMs field that is required when a timeRange is provided. The timeRange. startMs field represents an integer epoch timestamp in milliseconds that defines the beginning of the requested timeRange. The timeRange. startMs value is a smaller value than endMs. The request fields table 1300 further specifies a timeRange. endMs field that is required when a timeRange is provided. The timeRange. endMs field represents an integer epoch timestamp in milliseconds that defines the end of the requested timeRange. The timeRange. endMs value is a larger value than startMs.

As further shown in FIG. 13, the request fields table 1300 defines a userID field where one of userID or userEmail is required. The userID field represents the identifier of a user provided in identify calls made by the software application. The request fields table 1300 further defines a userEmail field where one of userID or userEmail is required. The userEmail field represents the email of a user provided in identify calls made by the software application. The userID and userEmail fields allow the system 100 to identify the user whose sessions should be summarized.

Referring again to FIG. 13, the request fields table 1300 defines a webhookURL field as required. The webhook URL field represents a URL to which highlights results may be posted when ready. The system 100 may transmit the query response 118 to the URL specified in the webhookURL field after processing the request and generating the LLM output(s) 128.

In some embodiments, the query response 118 generated by the system 100 may include key frames with timestamps, descriptions, video times, and file names that correspond to significant moments in the session. Each key frame entry may include a timestamp field indicating a time position in the session, a description field containing a natural language description of what occurred at that moment, a videoTime field indicating the video time in the session replay 120A or the session replay 120B, and a fileName field indicating a file name for an image captured at that moment. The key frames provide evidence points from the sessions that support statements made in the query response 118, allowing users to navigate to specific moments in the session replays where significant activity occurred.

In some embodiments, the query response 118 may include an estimated token cost for the processing performed. The estimated token cost may indicate the computational resources consumed by the LLM 108A when processing the prompt(s) 126 to generate the LLM output(s) 128. The estimated token cost may be expressed as a numerical value representing the token usage for the request. The inclusion of the estimated token cost in the query response 118 allows users to track and manage computational costs associated with session summary requests.

### Example Implementation of Some Embodiments for Summarizing Sessions

A software application may be accessed and used by thousands of users on a daily basis. For example, the software application may be a web application accessed by various users through an Internet browser application. As another example, the software application may be a mobile application accessed by various users using mobile devices (e.g., smartphones or tablets). The software application may thus be accessed by users in a large number of sessions every day by various user devices. A session refers to a time period in which a user interacts with a software application. A session may be represented by a sequence of events representing a user's perspective of operation of the software application in a time period. A session may be delimited by certain events. For example, a session of a web application may begin when a device accesses the web application using an Internet browser application and end when the device navigates away from the web application. As another example, a session of a mobile application may begin when the mobile application is initiated on a mobile device and end when the mobile application is closed. As another example, a session may end after a certain time period of inactivity.

Some embodiments (e.g., software application session understanding system 100 described herein with reference to FIGS. 1A-4) may be configured to automatically summarize digital experiences of users interacting with a software application. The techniques facilitate understanding the digital experience users of the software application are having across multiple different sessions. For example, the techniques herein may facilitate the identification of problems in the software application (e.g., errors, malfunctions, and/or unintended functionality), solutions to the problems, understanding and improving user experience, focusing development efforts, and/or other aspects of software development. As an illustrative example, some embodiments may be used to generate a summary of multiple software application sessions. The summary may, for example, highlight the most important or relevant aspects of user activity in the software application sessions.

Some embodiments provide a system for automatically summarizing digital experiences in which users interact with a software application in sessions of the software application. The system identifies, in the software application sessions, periods of user activity via a GUI of the software application (e.g., by identifying portions of the software application sessions in which there is at least a threshold frequency of user activity). The system samples images of software application GUIs displayed in the software application sessions during the identified periods of user activity. Sampling during periods when the user is inactive may be wasteful (i.e., more expensive) because it is unlikely that the system will obtain information relevant to understanding a user's experience during such periods. The system prompts a large language model (LLM) using the images of the software application GUIs to obtain a first output. The system prompts the LLM by providing the images of the software application GUIs as input to the LLM. The system may further provide a command or a request as part of the input. The system uses the first output to subsequently prompt the LLM to obtain a natural language summary of the software application sessions.

In some embodiments, the system may prompt the LLM using information in addition to images of software application GUIs. The system may sample information (e.g., about user activity) during identified periods of user activity. The system may prompt the LLM to obtain the first output by providing the sampled information as input to the LLM. For example, the system may provide a combination of the sampled information and images of software application GUIs as input to the LLM. The sampled information may, for example, be textual information (e.g., indicating events), numerical information, and/or other suitable types of information.

The system may sample images from identified periods of user activity in various ways. In some embodiments, for example, the system may use a dynamic sampling interval, use soft and hard frame limits, and/or use other suitable techniques of sampling images.

In some embodiments, the system may sample the images of the software application GUIs displayed in software application sessions in the identified periods by generating replays of the software application sessions. The system may sample the images of the software application GUIs from the session replays. Example techniques for generating session replays are described in U.S. Patent Application Publication No. 2024/0264730, published on Aug. 8, 2024, which is incorporated by reference herein in its entirety. In some embodiments, the system may map words in the natural language summary of the software application sessions to points in replays of software application sessions. For example, the system may associate a link with a word (e.g., that can be accessed by selecting the word) that provides access to a point in a session replay (e.g., when selected). The system may prompt the LLM for key moments in replays of the software application sessions and for words in the natural language summary associated with those key moments. The system may map the words indicated by output of the LLM to points in session replays.

In some embodiments, the system may sample a set of images of software application GUIs from period(s) in each of the software application sessions. The system may prompt the LLM for a description of what is occurring in each of the sets of software application GUI images. The system may thereby obtain a description corresponding to each of the sets of software application GUI images. In some embodiments, the description of a set of software application GUI images may have an associated indication of a point in a respective software application session (e.g., a timestamp in a replay of the software application session). In some embodiments, the system may serially prompt the LLM using each of the sets of software application GUI images. In some embodiments, the system may prompt the LLM using each of the sets of software application GUI images in parallel. In other words, it allows the system to “watch” a session very quickly. The system may use the descriptions obtained for each of the sets of software application GUI images to subsequently prompt the LLM for the natural language summary of the software application sessions. In some embodiments, the prompt may also request the LLM for an indication of key software application GUI images (e.g., key frames) that are relevant to the natural language summary (e.g., to be mapped to words in the summary) and for linked text in the natural language summary that provides access to points that the GUI images appear in a session replay.

In some embodiments, the system may prompt the LLM using each of multiple sets of software application GUI images in parallel (e.g., using multiple instances of the LLM in parallel) to obtain a corresponding description for each set. The system may reduce the descriptions obtained for the sets of software application GUI images (e.g., by summarizing the descriptions) to produce an overall description of the session. For example, the system may prompt the LLM to summarize the descriptions obtained for the sets of software application GUIs. Prompting the LLM in parallel to obtain multiple descriptions and then reducing the descriptions may dramatically lower the time required to obtain a summary compared to processing all the sets of software application GUI images sequentially or in a single prompt. In other words, the system may process a session more quickly.

In some embodiments, the system may generate the natural language summary based on a user query. In some embodiments, the user query may request information about software application sessions and/or information about an issue encountered in software application sessions. The user query may be received through a communication interface (e.g., a chat interface, an email, or other communication interface). The system may provide the user query as input in the prompt for the natural language summary of the software application sessions. The LLM may thus provide a summary that is relevant to the user query. For example, the user query may specify a request for a description of an issue that occurred in the software application sessions. In some embodiments, a user query in this context may include a user's description of an issue the user experienced. For example, the user's description of the issue may be intended for a customer support representative (e.g., a complaint submitted to a ticketing system, to a chat bot, or another system configured to receive user queries). The system may then use that description of the problem as additional context when summarizing the user's session(s). This allows the system to generate a summary that's tailored to the user's complaint with links that pinpoint relevant moments in their session(s). The natural language summary provided by the LLM based on the first input may provide a description of the issue that occurred in the software application sessions.

In some embodiments, a generated summary may be posted to a provided uniform record locator (URL) (e.g., a webhookURL). For example, the summary may be posted in the following format with a status of READY along with a requestID corresponding to the one returned from the original POST request. Each session that has been summarized will be included in the result. The result is the summary across all included sessions. Summary strings are returned with links to relevant portions of the session provided in Markdown format.

In some embodiments, only sessions in a retention period will be included in the result.

### Example Computer System

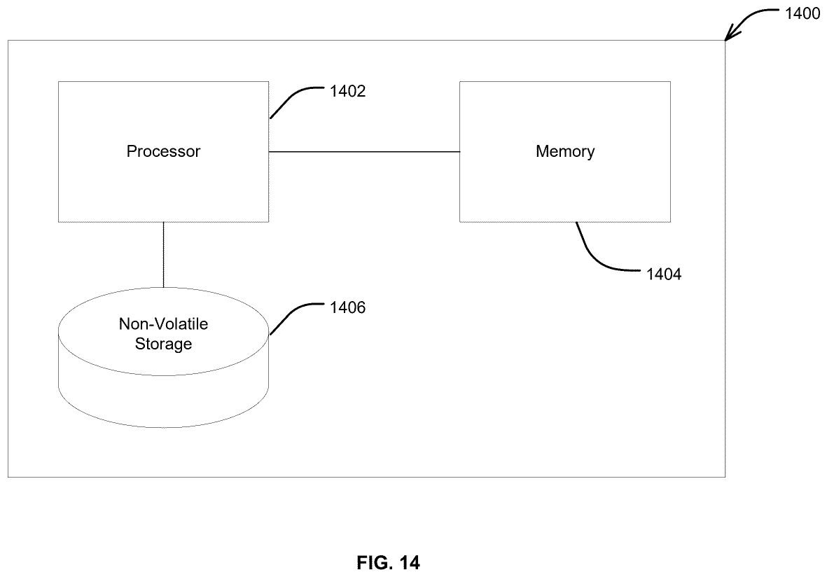

FIG. 14 below is an example computer system 1400 which may be used to implement some embodiments of the technology described herein. The computer system 1400 may include one or more computer hardware processors 1402 and non-transitory computer-readable storage media (e.g., memory 1404 and one or more non-volatile storage devices 1406). The processor(s) 1402 may control writing data to and reading data from (14) the memory 1404; and (2) the non-volatile storage device(s) 1406. To perform any of the functionality described herein, the processor(s) 1402 may execute one or more processor-executable instructions stored in one or more non-transitory computer-readable storage media (e.g., the memory 1404), which may serve as non-transitory computer-readable storage media storing processor-executable instructions for execution by the processor(s) 1402.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. As used herein, the term “computer-readable storage medium” encompasses only a non-transitory computer-readable medium that can be considered to be a manufacture (i.e., article of manufacture) or a machine. Alternatively or additionally, aspects of the technology described herein may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor, but may be distributed in a modular fashion amongst a number of different computers or processors to implement various aspects of the technology described herein.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by an “actor” or a “user.” It should be appreciated that an “actor” or a “user” need not be a single individual, and that in some embodiments, actions attributable to an “actor” or a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A large language model (LLM)-based software application session understanding system, the system comprising:
a processor; and
a non-transitory computer-readable storage medium storing instructions that, when executed by the processor, cause the processor to:
receive a query requesting information about at least one software application session of a software application;
obtain a plurality of images of graphical user interface (GUI) content displayed at points in the at least one software application session;
generate textual annotations for the plurality of images of GUI content displayed at the points in the at least one software application session;
process, using a large language model (LLM), the plurality of images of the GUI content and the textual annotations for the plurality of images to obtain LLM output, the processing comprising:
generate at least one prompt for the information requested by the query at least in part by including, in the at least one prompt, the plurality of images combined with the textual annotations and instructions for the LLM; and
communicate with the LLM using the at least one prompt to obtain the LLM output; and
generate a response to the query using the LLM output obtained from processing the plurality of images of the GUI content and the textual annotations.

2. The system of claim 1, wherein generating the at least one prompt including the plurality images combined with the textual annotations comprises:
include, in the at least one prompt, instructions to output the information about the at least one software application session requested by the query.

3. The system of claim 1, wherein receiving the query comprises receiving, through a communication network, the query from an external system and the instructions further cause the processor to:
transmit, through the communication network, the response to the query generated using the LLM output.

4. The system of claim 1, wherein generating the at least one prompt including the plurality of images combined with the textual annotations comprises:
include, in the at least one prompt, a specification of one or more functions that can be triggered for execution by the LLM to obtain additional information.

5. The system of claim 4, wherein communicating with the LLM using the at least one prompt to obtain the LLM output comprises:
trigger, by the LLM responsive to a first prompt of the at least one prompt, execution of a first function of the one or more functions, wherein triggering the execution of the first function generates a first set of information;
process, using the LLM, the first set of information generated from execution of the first function to generate the LLM output.

6. The system of claim 4, wherein the one or more functions include one or more of:
a network information acquisition function that, when executed, obtains information about network requests and/or responses at one or more points in the at least one software application session;
a log information acquisition function that, when executed, obtains information about messages logged to a console at one or more points in the at least one software application session; and/or
a metadata acquisition function that, when executed, obtains metadata about the at least one software application session.

7. The system of claim 4, wherein triggering the execution of the first function comprises:
receive, from the LLM, a request to execute the first function; and
execute the first function in response to the request to generate the first set of information.

8. The system of claim 1, wherein obtaining the plurality of images of the GUI content displayed at the points in the at least one software application session comprises:
generate at least one replay of the at least one software application session; and
capture the plurality of images of the GUI content from the replay of the at least one software application session.

9. The system of claim 8, wherein generating the response to the query using the LLM output comprises:
obtain, from the LLM output, a set of text to include in the response to the query; and
embed, in the set of output text, one or more links that each navigate to a particular point in the at least one replay of the at least one software application session.

10. The system of claim 1, wherein generating the at least one prompt for the LLM comprises:
including, in the at least one prompt, information that configures operation of the LLM.

11. The system of claim 1, wherein:
receiving the query requesting information about the at least one software application session comprises receiving a query requesting a summary of user activity in the at least one software application session; and
communicating with the LLM using the at least one prompt to obtain the LLM output comprises communicating with the LLM to obtain a natural language summary of the user activity in the at least one software application session.

12. The system of claim 11, wherein obtaining the plurality of images of GUI content displayed at the points in the at least one software application session comprises:
obtaining images of GUI content displayed at points in the at least one software application session when user actions are being performed in the GUI.

13. The system of claim 1, wherein generating the textual annotations for the plurality of images of the GUI content displayed at the points in the at least one software application session comprises:
generating, for each of at least one of the plurality of images of GUI content, text describing a user action being performed at a particular one of the points in the at least one software application session.

14. A method for performing large language model (LLM)-based software application session understanding, the method comprising:
using a processor to perform:
receiving a query requesting information about at least one software application session of a software application;
obtaining a plurality of images of graphical user interface (GUI) content displayed at points in the at least one software application session;
generating textual annotations for the plurality of images of GUI content displayed at the points in the at least one software application session;
processing, using a large language model (LLM), the plurality of images of the GUI content and the textual annotations for the plurality of images to obtain LLM output, the processing comprising:
generating at least one prompt for the information requested by the query at least in part by including, in the at least one prompt, the plurality of images combined with the textual annotations and instructions for the LLM; and
communicating with the LLM using the at least one prompt to obtain the LLM output; and
generating a response to the query using the LLM output obtained from processing the plurality of images of the GUI content and the textual annotations.

15. The method of claim 14, wherein generating the at least one prompt including the plurality of images combined with the textual annotations comprises:
including, in the at least one prompt, a specification of one or more functions that can be triggered for execution by the LLM to obtain additional information.

16. The method of claim 15, wherein communicating with the LLM using the at least one prompt to obtain the LLM output comprises:
triggering, by the LLM responsive to a first prompt of the at least one prompt, execution of a first function of the one or more functions, wherein triggering the execution of the first function generates a first set of information;
processing, using the LLM, the first set of information generated from execution of the first function to generate the LLM output.

17. The method of claim 16, wherein triggering the execution of the first function comprises:
receiving, from the LLM, a request to execute the first function; and
executing the first function in response to the request to generate the first set of information.

18. The method of claim 14, wherein obtaining the plurality of images of the GUI content displayed at the points in the at least one software application session comprises:
generating at least one replay of the at least one software application session; and
capturing the plurality of images of the GUI content from the replay of the at least one software application session.

19. The method of claim 14, wherein generating the response to the query using the LLM output comprises:
obtaining, from the LLM output, a set of text to include in the response to the query; and
embedding, in the set of output text, one or more links that each navigate to a particular point in the at least one replay of the at least one software application session.

20. A non-transitory computer-readable medium storing instructions that, when executed by a processor, cause the processor to perform a method for performing large language model (LLM)-based software application session understanding, the method comprising:
receiving a query requesting information about at least one software application session of a software application;
obtaining a plurality of images of graphical user interface (GUI) content displayed at points in the at least one software application session;
generating textual annotations for the plurality of images of GUI content displayed at the points in the at least one software application session;
processing, using a large language model (LLM), the plurality of images of the GUI content and the textual annotations for the plurality of images to obtain LLM output, the processing comprising:
generating at least one prompt for the information requested by the query at least in part by including, in the at least one prompt, the plurality of images combined with the textual annotations and instructions for the LLM; and
communicating with the LLM using the at least one prompt to obtain the LLM output; and
generating a response to the query using the LLM output obtained from processing the plurality of images of the GUI content and the textual annotations.
